(19) United States
(12) Patent Application Publication
(10) Pub. No.: US 2010/0120128 A1
(43) Pub. Date: May 13, 2010

(54) Eco-engineering for systematic carbon mitigation

(76) Inventor: Zhi-Wei Liang, Coquitlam (CA)

Correspondence Address: Ning Qian, 1805 Maryland Dr, Elk Grove Village, IL, 60007, US

(21) Appl. No.: 12/456,254

(22) Filed: Jun. 15, 2009

(30) Foreign Application Priority Data
Jun. 18, 2008 (CN) 200810110944.9

(51) Int. Cl. B01D 53/62

(52) U.S. Cl. 435/266; 423/226

(57) ABSTRACT

To deal with climate change, the present invention provides an eco-engineering for systematic carbon mitigation, in particular, a comprehensive carbon management system with a group of Stabilized Functional Carbons (SFCs) to reduce the total amount of carbons in atmosphere. SFCs are sourced and manufactured from the carbon-fixed biomass by one of the seven thermo-chemical treatments or one dehydration treatment with no less than 75% carbon conversion rates of the source material. The present invention transforms the perishable biomass into SFCs, which act as a carbon sink with stability and safety for at least 40 years' storage. The primary eco-friendly carbon and non-carbon mitigation are achieved by the sourcing, manufacturing and storage of SFCs. The advanced eco-friendly carbon and non-carbon mitigation are achieved at various pollution emission sources by the resource utilization of SFCs. An annual total amount of 0.5-10 billion tons of carbon emission could be reduced globally.

### FIELD OF THE INVENTION

The invention involves an eco-engineering mechanism for systematic carbon mitigation to fight climate change, especially involves a carbon management system that consists of a group of Stable Functional Carbons (SFCs) and their raw material sourcing, manufacturing, storage and resource utilization, in order to reduce the total amount of carbons and other pollution in atmosphere. The storage of SFCs as the carbon carriers results in primary carbon and non-carbon mitigation, while utilization of SFCs as functional resources at various pollution emission sources results in advanced carbon and non-carbon mitigation.

### BACKGROUND OF THE INVENTION

In nature, the total amount of carbon is in a dynamic equilibrium, and in a circulation as Carbon Cycle (CC). Since the Industrial Revolution, a huge amount of carbon resources from underground has been excavated, giving rise to a marked increase of total carbon in CC. The total carbon in the global system is seriously imbalanced or carbon-positive, resulting in dramatic increase in concentrations of atmospheric carbon dioxide (CO₂), methane (CH₄) and other greenhouse gases (GHGs), contributing to climate change. Climate change is triggering a series of disastrous consequences that threat to the survival of mankind and creatures.

The known carbon mitigation technologies can be categorized into three groups. The first is to directly reduce the emission of CO₂ and CH₄ into atmosphere, turning carbon-positive to carbon-neutral, for example, to capture CO₂ during fossil fuel combustion and store the CO₂ underground or in the deep sea; to recover and make use of gas from coal mining; to control flatus of livestock; and to turn CH₄ that has strong greenhouse effect into CO₂. The second is to control the consumption of energy and related carbon resources. It does not reduce the total amount of carbon that has already entered the CC, but turns carbon-positive to carbon-neutral. For example, renewable energy and efficient power generation are developed; waste heat is re-used; energy-saving insulation in buildings is developed; other resources are re-used and recycled. The third is to control the mobility of non-CO₂ and non-CH₄ carbon resources, by extending carbon life in a non-gaseous state in CC; or turning the active carbon into stable carbon for storage. It turns carbon-positive to carbon-neutral or even carbon-negative. One example, forestation, which affixes CO₂ in trees by photosynthesis, can stably store the solid carbon for several decades, resulting in carbon-neutral. Another example, manufacturing of biochar from biomass at oxygen-free condition, keeping carbon away from active CC and reducing the total amount of carbon circulated inside CC, is good for carbon-negative.

However, the known carbon mitigation technologies are largely limited by their practical effects, which are not powerful enough to change the state of severe carbon imbalance and to fight climate change. The problems are: heavy side effects; very high cost; technical uncertainty; unstable products (such as leakage); negative environmental effects; global imbalance of socio-economic development; and restrains in conditions of implementation. In addition, the known arts try to solve mainly a particular factor in the complex global system, therefore their effects are of scattered, non-systematic, inefficient, waste of resources, and utilization of resources at lower level.

The challenge of climate change is on a global scale, so the solution has to be globe-wide and systematic. The future carbon mitigation technology needs to meet simultaneously the scale feasibility, economic viability, resource feasibility, ecological viability and technical feasibility. Future carbon mitigation technology should have the following trends: 1. From a final mitigation effect perspective, carbon-neutral is only a start, and carbon-negative should be the ultimate goal; 2. From a systematic perspective, for a complex system where GHGs are from various sources in CC, the scattered, small scaled and one-factor only designed mitigation could not fight climate change effectively, but the integrated, large-scaled and systematic designed mitigation should be more effective. 3. From a sustainable development perspective, the sharp contradiction of high mitigation costs and economic development has to be solved, otherwise it is not sustainable. Technologies that have more sustainable prospects should be those that integrate mitigation, products for and from the mitigation, and economic utilization of the products to make beneficial impacts on society, economy, environment, ecology and pollution control.

Similar to climate change, the problems of energy-source shortage, crop debris, building energy waste, waste plastics and scrap tires pollution, pollution of agriculture and breeding industry, persistent organic pollutants (POPs), chemical pollution and electromagnetic pollution, are the global issues that are difficult solve but important to the sustainable development of mankind. These problems seem complicated and isolated from each other, but are all related to climate change and carbon dependent, forming a giant “carbon” cycling system to influence GHGs. Therefore, a sustainable carbon mitigation system should consist of both a stable carbon sink and an effective pollution control for various emission sources.

The biochar and activated carbon from the natural plant biomass, and the dewatering drying mummy from animal and plant biomass, have been proved to be a carbon sink of ultra-long-term stability and security. For example, a 2100 years' old tomb excavated in China (Mawangdui Han Tomb One), was found to be covered with up to five tons of charcoal around the tomb, the unearthed woman body and plant seeds were not even decomposed. It might be the charcoal, a stabilized carbon carrier that had made itself and the surrounding organic bodies well preserved and lasted for 2100 years.

The modification of natural carbon resources is often done by different chemical treatments in different air media, different liquid or solid media with different courses, different temperatures and different reaction times, resulting in different modified products. U.S. Pat. No. 4,553,978 (Yvan) discloses a process for converting ligneous matter of vegetable origin by torrefaction in a neutral atmosphere at a temperature of between 200° and 280° C., and preferably between 240° and 260° C., for duration of 30 minutes to 5 hours. U.S. Pat. No. 5,585,319 (Saitoh) discloses a process for preparing oil sorbent by heating lignocellulose at a temperature of 250° C. to 450° C. for 5 to 100 minutes in a rotary oven. U.S. Pat. No. 4,448,589 (Fan et al) discloses a pyrolytic conversion of carbonaceous solids to fuel gas in quartz sand fluidized beds as the primary inert heat-transfer medium at a temperature of 738° C. to 788° C. GB 1409130 (Liang et al) discloses an oxidative thermo-chemical dry process to convert natural carbon materials to produce hydrophobic oleophilic materials and sorbents at a temperature of 80° C. to 700° C. for 1 min to 24 hours.

### OBJECTIVES OF THE INVENTION

The carbon solution should be performed in a comprehensive and systematic manner with all aspects taken into account and with emphases on multiple purpose utilization and achieving maximum environmental and economic benefits so as to allow full utilization of carbon resources and to promote the coordinated development of carbon-economy, carbon-pollution control and carbon-climate.

Based on the principle of CC, seeking an eco-solution of carbon sink for rebalancing the global carbon imbalance; seeking the link between economic development and carbon mitigation, energy resource shortage, crop waste, building energy-saving, “white” and “black” pollution, agriculture pollution, food safety, POPs, chemical pollution and electromagnetic pollution; and seeking economic utilization of carbon sink for low-carbon economy and pollution control.

### SUMMARY OF THE INVENTION

The applications of the known arts for carbon mitigation are highly restricted by their scale feasibility, economic viability, resource feasibility, ecological viability and technical feasibility. To overcome the above shortcomings, the present invention discloses a general process of converting the biomass resources which contain large quantities of carbons and non-carbons into a group of solid, stable, hydrophobic and functionalized carbon carriers, namely Stable Functional Carbons (SFCs). The eco-engineering for the systematic carbon mitigation is made up with the sequentially-linked mitigation subsystems including the raw material sourcing, manufacturing, storage and resource utilization of SFCs, and results in reducing the total amount of carbon in atmosphere. The perishable raw plant biomass is treated and becomes stabilized as SFCs in one of the seven different heat processes. The perishable raw animal and plant biomass is treated and becomes stabilized as SFC-VIII in one dehydrated process. No less than 75% of carbons from raw biomass are retained after the treatments. SFCs could keep the structured carbons and non-carbons inside safely for at least 40 years. The storage of SFCs as the carbon carrier results in primary carbon and non-carbon mitigation, while utilization of SFCs as functional resources at various pollution emission sources results in advanced carbon and non-carbon mitigation. The engineering is able to reduce 0.5-10 billion tons of carbon and of scale feasibility, economic viability, resource feasibility, ecological viability and technical feasibility, achieving the objects of sizable carbon-negative, optimizing carbon mitigation, minimizing carbon emission and pollution, and optimizing carbon utilization in economic development.

The present invention provides a general process to reduce the total amount of carbons in atmosphere by answering the following carbon-related questions and their comprehensive carbon management: Where are the carbons? Which state of the carbons is good for carbon control? How to capture and fix the carbons? How to stabilize the carbons? Is the stabilizing treatment cost-effective and eco-friendly? Are the stabilized carbons safe? How to store the carbon products? Are the carbon products useful? Can the carbon products play a role in economic development? Can the resource utilization of carbon products reduce more carbon emission and other pollution?

Carbons in CC exist in dynamic balance as in gaseous, liquid and solid states. In general, capture and storage of carbons in any state should provide solutions for carbon mitigation. However, the gaseous carbons are difficult to capture and store, and its resource utilization is less accessible; the solid carbons are easy to capture and store, and its resource utilization is much more accessible; the liquid carbons are somewhere in between. Therefore, the best developing direction for global carbon mitigation is to capture and store the solid carbons. Among the various resources of solid carbons, the plants and animal bodies that exist in large quantity in CC are the best source of raw solid carbon materials.

Principle of the present invention for carbon mitigation: When plants live, they affix gaseous CO₂ by photosynthesis and store the solid organic carbon molecules inside the plant bodies; when animals live, they capture and store the solid organic carbon molecules as the animal bodies. When the plants and animals die, the solid organic carbon molecules are decomposed by natural processes; and GHGs are released into atmosphere. When dead biomass is stabilized by the present invention, the active and perishable carbons in them are turned into a stable carbon sink. When the stabilized carbon sink is long-term stored or utilized in a non-destructive manner, little GHGs are released from the sink for at least several decades; reducing the total amount of carbons in CC; thus the primary eco-friendly carbon and non-carbon mitigation are achieved. When the stabilized sink is further utilized as functional resources in a non-destructive manner, the advanced carbon and non-carbon mitigation can be achieved from many carbon emission sources, such as in Cleaner Production and low-carbon economy. The whole process is carbon-negative to the atmospheric GHGs.

### DESCRIPTION OF THE PREFERRED EMBODIMENTS

The process for preparing the first carbon product SFC-I comprises of heating the mixed raw plant biomass covered by a layer of granules in a thermo-chemical apparatus or kiln, in an oxygen-free environment at a temperature of 150° C. to 350° C., preferably 180° C. to 320° C., for 0.5-24 hours, preferably 1-5 hours. The raw biomass is mixed with 0-95% (v/v) stabilizing agent before the heat treatment. The stabilizing agents can form a layer of protection on the surface of biomass for long-term stability. Suitable stabilizing agents include plant fruits, petroleum by-products, proteins, fats, gels, surfactants, chelators, sugars, inorganic salts, acids and combinations thereof. The mixed raw biomass is covered by a layer of heat-conducting granules. The granules include silica sands or iron sands. The layer of granules conducts the heat and permits the produced gaseous moisture and volatile substances to escape, and prevents the outside air oxygen from contacting biomass. The carbon retention ratio of SFC-I from raw materials to products is 85-95%, and the non-carbon retention ratio is over 75%.

The process for preparing the second carbon product SFC-II comprises of sun heating the mixed raw plant biomass covered by a layer of granules for 2 min-5 hours. The sun heating is collected by a concave mirror or a group of concave mirrors. The raw biomass is mixed with 0-95% (v/v) stabilizing agent before the heat treatment. The stabilizing agents can form a layer of protection on the surface of biomass for long-term stability. Suitable stabilizing agents include plant fruits, petroleum by-products, proteins, fats, gels, surfactants, chelators, sugars, inorganic salts, acids and combinations thereof. The mixed raw biomass is covered by a layer of heat-conducting granules. The granules include silica sands or iron sands. The layer of granules conducts the heat and permits the produced gaseous moisture and volatile substances to escape, and prevents the outside air oxygen from contacting the biomass material. The carbon retention ratio of SFC-II from raw materials to products is 85-95%, and the non-carbon retention ratio is over 75% .

The process for preparing the third carbon product SFC-III comprises of microwaving raw plant biomass covered by a layer of silica sands in an oxygen-free environment for 5 min-5 hours, preferably 10 min-2 hours. The raw biomass is mixed with 0-95% (v/v) stabilizing agent and 0-0.5 M microwave-sorbing medium before the heat treatment. Suitable stabilizing agents include plant fruits, petroleum by-products, proteins, fats, gels, surfactants, chelators, sugars, inorganic salts, acids and combinations thereof. Suitable microwave-sorbing media are the materials with higher dielectric constant, such as ethanol, acids, alkalis, salts and sea water, to change microwave electromagnetic energy into heat energy. The cover layer of silica sands conducts the microwave and heat and permits the produced gaseous moisture and volatile substances to escape, and prevents the outside air oxygen from contacting biomass. The carbon retention ratio of SFC-II from raw materials to products is 85-95%, and the non-carbon retention ratio is over 75% .

By adding 0-95% (v/v) stabilizing agent, such as plant fruits, petroleum by-products, proteins and fats to prepare SFC-I, SFC-II or SFC-III, the raw plant biomass undergoes thermal or microwave action and some of its chemical bonds are broken; the moisture and volatile substances are released; the structural hydrophobicity (non-polar, weak polar, or oil loving) is enhanced; the chemical structure is stabilized; the anti-biodegradation capability is increased; then a hydrophobic and weak polarity carbon carrier is formed. The cover granules also become hydrophobic by heat coating with volatile substances.

By adding 0.1-10% (v/v) hydrophilic stabilizing agent, such as carboxymethyl cellulose (CMC), surfactants, chelators, inorganic salts and acids to prepare SFC-I, SFC-II or SFC-III, the raw plant biomass undergoes thermal or microwave action and some of its chemical bonds are broken; the moisture and volatile substances are released; the structural hydrophilicity (polar, or water loving) is enhanced; the chemical structure is stabilized; the anti-biodegradation capability is increased; a hydrophilic and strong polarity carbon carrier is formed.

The fourth carbon product SFC-IV, is prepared in an oxidative thermo-chemical process by Liang et al (ZL01823477.1, GB1409130, FR1409130, GE1409130, AU2001275621 and RU2277967). The process provides an oil sorbent preparation and its product applications. The known invention has no intention for carbon mitigation, but has the objective to prepare and apply as the hydrophobic/hydrophilic sorbents. The used sorbents are destructively degraded b_{y} burning or biodegradation.

The inventor of present invention accidentally found that after the oxidative thermo-chemical treatment, the unstable and easily degraded raw biomass became stabilized and was difficult for biodegradation. It is an unexpected result. When it was stored or utilized as a resource, the treated product had long-term stability to lock the solid carbon inside for carbon mitigation. To function for carbon mitigation, the present invention aims at the long-term storage or resource utilization of carbon products, and avoids the destructive degradation of carbon products.

The process for preparing the fourth carbon product SFC-IV comprises of heating the moist raw plant biomass in a thermo-chemical convection apparatus or kiln equipped with a gas flow system, in an oxidizing medium at a temperature of 110° C. to 350° C., preferably 150° C. to 260° C., for 5 min to 5 hours. The oxidizing medium flows around the biomass, and takes away the vaporized moisture and volatile substances. The oxidizing medium can be in gaseous or aqueous state, such as air (containing 21% oxygen), oxygen, ozone, hydrogen peroxide or any oxygen-containing material capable of releasing oxygen or highly reactive free radicals under the oxidation conditions.

During the oxidative thermo-chemical process, the raw biomass of SFC-IV undergoes oxidation and some of its chemical bonds are broken; the moisture and volatile substances are released; the surface and internal oxygen groups are increased; the structural hydrophobicity is enhanced; the chemical structure is stabilized; the anti-biodegradation capability is increased; a hydrophobic and weak polarity carbon carrier is formed. The carbon retention ratio of SFC-IV from raw materials to products is 90-99%, and the non-carbon retention ratio is over 80% .

The process for preparing the fifth carbon product SFC-V comprises of a two-step treatment process: the first treatment of raw plant biomass in the oxidative thermo-chemical process as for SFC-IV, then the second treatment in the oxygen-free thermo-chemical process as for SFC-I. The carbon retention ratio of SFC-V from raw materials to products is 75-90%, and the non-carbon retention ratio is over 50% .

The process for preparing the sixth carbon product SFC-VI comprises of a two-step treatment process: the first treatment of raw plant biomass in the oxidative thermo-chemical process as for SFC-IV, then the second treatment in the oxygen-free thermo-chemical process as for SFC-II. The carbon retention ratio of SFC-VI from raw materials to products is 75-90%, and the non-carbon retention ratio is over 50%

The process for preparing the seventh carbon product SFC-VII comprises of a two-step treatment process: the first treatment of raw plant biomass in the oxidative thermo-chemical process as for SFC-IV, then the second treatment in the oxygen-free microwave chemical process as for SFC-III. The carbon retention ratio of SFC-VIII from raw materials to products is 75-90%, and the non-carbon retention ratio is over 50% .

During the preparation of SFC-V, SFC-VI and SFC-VII, the raw biomass undergoes the sequential treatment of the oxidative thermo-chemical process and the oxygen-free thermo(or microwave) chemical process; more chemical bonds are broken; more moisture and volatile substances are released; the surface and internal oxygen groups are increased; the porous structures are increased; the chemical structure is stabilized; the anti-biodegradation capability is more stronger than that of SFC-I, SFC-II, SFC-III and SFC-IV; the long-term stabilized carbon carrier are thus formed. The hydrophobic or hydrophilic characteristic of the products also relies on the nature of stabilizing agent in the oxygen-free thermal (microwave) chemical process.

The process for preparing the eighth carbon product SFC-VIII comprises of a pre-dehydration of the raw animal and plant biomass, and a long-term dehydration/maintenance condition to keep the products dehydrated. The pre-dehydration can be done in one or mix of the following treatments: air-dry, sun-dry, fire-dry, salt-dry, microwave, roast-dry, and sun dry by focalizing lens. The biomass is pre-dehydrated to a water content of 10-20%, then buried in desert or put into a pyramid building for further dehydration thus the dehydrated status is kept for long. The higher extent of dehydration, the better stability and anti-biodegradation of the carbon structure is achieved. The pyramid energy in the pyramid building inhibits oxidation and biodegradation of the carbon materials, and dehydrates the carbon materials continuously to a water content of lower than 8%. The carbon retention ratio of SFC-VIII from raw materials to products is 75-99%.

SFCs, including SFC-I, SFC-II, SFC-III, SFC-IV, SFC-V, SFC-VI, SFC-VII and SFC-VIII, are prepared from the raw materials of terrestrial and marine carbon-B stock (see FIG. 1). In the carbon B stock, the crop stalks and garden waste are the most economic raw material resources. For example, only small portion of crop stalks in the world are now used for feed, fertilizer and biomass energy, however, most of global crop stalks are discarded in farmland or burned, producing CO₂, CH₄, N₂O, smoke and other pollutants. In China, for example, the annual output of crop stalks is about 720 million tons, forest waste is about 1 billion tons, so the national supply can provide the raw materials for as much as 1 billion tons of SFCs. The animal raw materials, often due to their high economic value, are limited for purpose of carbon mitigation. Severely polluted animal resources such as animal resources that polluted by heavy metals or POPs and should not go back to the biosphere, could be used as the raw materials for the purpose of carbon mitigation.

Storage of SFCs can achieve the primary eco-friendly carbon mitigation. The invented plant SFCs, as the stable carbon carrier, could be stored or utilized in an easy-applied and easy-maintained condition for carbon mitigation, without deep burial. The animal or plant SFC-VIII is better suited to a storage site in the desert or in the pyramid warehouse for carbon mitigation. Although, the longer SFCs stability is, the better it plays a role in carbon mitigation. In practice, as long as SFCs show the same carbon sink ability as that of living trees, equivalent to the average life time 40-50 years, SFCs could play the same role as the living trees in carbon mitigation. The ecological stability and biological degradation of SFCs is highly related to the SFCs' storage or utilization-conditions. The influence factors involve humidity, temperature, oxygen content, pH and the surrounding environment. In general, SFCs in a closed drying environment are more stable. SFCs are relatively not stable when they are in the environment of high humidity and adequate nutrition for microbial growth; or in strongly acidic or strongly alkaline environment; or in the digestive tracts of herbivorous animals; or in the Agaricus mushroom medium. A good reference of biodegradable plant materials for longer stability at the proper maintenance condition is the crop stalks-clay house. The house is made of mixture of crop stalks and clay, and its average service lifetime is 40-50 years or longer. Other references are, fir wood (12% moisture) for construction material with stable life of 40 years, wood frame material (19% moisture) with 75 years, the insulating material made of the newspaper fiber with over 50 years, see Lippiatt, Building for Environmental and Economic Sustainability/Technical Manual and User Guide, 2007. One can reasonably expect that when SFCs have much stronger anti-biodegradation and hydrophobic characteristics than the natural raw materials, the stable lifetime of SFCs will be more than 40 years.

Storage of SFCs can also achieve the primary eco-friendly non-carbon mitigation. The carbon skeletons of SFCs carry one or more of the non-carbon elements from plant or animal, such as nitrogen, sulfur, phosphorus, arsenic and heavy metals. The non-carbon elements are bound parts of the SFCs in a stable state. Therefore, storage of SFCs reduces the GHGs and other pollutants from the non-carbon factors.

Although the long-term stability test of plant SFCs, or animal and plant SFC-VIII has not been finished yet, some facts show that SFCs do have certain physical stability, chemical stability and anti-biodegradation stability. See Examples 2-5, 8-9, 14-16, 21-23, and 42.

SFC-I, SFC-II, SFC-III and SFC-IV are expected to have long-term stability for at least 40 years, after the single treatment of oxygen-free thermo-chemical process, or oxygen-free microwave thermo-chemical process or oxidative thermo-chemical process. On the other hand, SFC-V, SFC-VI and SFC-VII are expected to have long-term stability for at least 100 years, after the sequential treatments of oxidative thermo-chemical process and oxygen-free thermo-chemical process. For example, SFC-IV produced from the oxidative thermo-chemical process has light wood aroma and releases some soluble colored substances in water, indicating that SFC-IV contains certain amount of unstable, soluble and volatile materials. SFC-V and SFC-VI produced from further treatment of SFC-IV, however, are odorless and colorless in water, indicating that SFC-V and SFC-VI contain little amount of unstable, soluble and volatile materials; the stability of the chemical structure and anti-biodegradation are evidently enhanced.

The long-term stability of SFCs can be substantially improved by tight seal, landfill or integration in the protection materials. Tight seal or landfill provides the external protection for SFCs, while integration enables the protection materials and SFCs to form a uniform dense structure, all the treatments endow SFCs with a more stable micro-environment, less oxygen exposure, less moisture, less light and less microbial decomposition. The common and largely available protection materials include inorganic materials and organic polymer materials. Inorganic materials include hydrophilic materials, such as fly ash, coal gangue, slag, clay, rock wool, glass wool, stone powder, sand, cement, lime, gypsum, and etc. Organic polymer materials include hydrophobic materials, such as plastics, rubbers, resins, polypropylene, paraffin wax, Vaseline, asphalt, and etc; Organic polymer materials also include hydrophilic material of CMC, chitosan and surfactants. The hydrophobic organic polymer materials are more efficient than inorganic materials for the protection of the hydrophobic SFCs. In addition, see Lippiatt (2007), PVC used for building materials has stable lifetime over 50 years, gypsum board over 75 years, parking lot asphalt paving material over 50 years, fiber cement 45 years and wood-plastic (PE) 50 years. One can reasonably expect that when SFCs are integrated with plastic or asphalt, the stable lifetime of the mixture will be 50-100 years.

The long-term stability of SFCs can also be improved by treatment of alkaline cellulose, or calcium phosphate/calcium carbonate, or alkaline silication. By the treatment, an external protection for SFCs is formed, thus endows SFCs with a more stable micro-environment, less oxygen exposure, less microbial decomposition, more fire-retardation and better security of storage. One can reasonably expect that the stable life time of the treated SFCs will be up to 100 years. See example 34-35.

The long-term stability of SFCs can also be improved substantially by high-pressure compressed storage or vacuum-packed storage after high-pressure compressing. After the treatment, less storage space is needed; transportation costs and storage costs are reduced; porosity of SFCs is reduced; oxygen exposure and microbial decomposition are reduced; fire-retardation and waterproofing are improved; and extra protective layer is provided. The storage stability of SFCs is improved by more than 20%. One can reasonably expect that the stable lifetime of the treated SFCs will be at least 100 years.

The long-term stability of animal and plant SFC-VIII is related to the degree of dehydration and the storage conditions. The higher the degree of dehydration is, the longer stability of carbon structure obtains. It is expected that the long-term stability of animal SFC-VIII is at least 100 years when the moisture content is below 5%.

The ecological safety of SFCs is shown in Examples 2, 6-11, 21-22, 27-29, 33 and 42. The preliminary results indicate that SFCs are of no harm and no risk to the ecological system. However, bulk state of SFCs is combustible, fire precaution is necessary.

Comparing the primary carbon mitigation effect of the invented SFCs with known arts of CO₂ capture and storage (CCS), their mitigation mechanisms are different; the process costs, energy consumption, safety, efficiency, effectiveness and commercial value are also different. CCS captures gaseous CO₂ by chemical reactions from coal-power factories, and transports the captured CO₂ as a waste to deep underground for storage. CCS reduces the carbon emission directly and rapidly, and leads to carbon neutral. Capture of one ton CO₂, is equivalent to store 273 kg carbon. However, CCS is very costly, and consuming large quantities of chemicals and energy. CCS catches one carbon atom with two oxygen atoms, thus, sizable application of CCS may cause a huge consumption and imbalance of oxygen in nature. In addition, the captured CO₂ or its salts has limited commercial value; the potential leakage of stored CO₂ may cause ocean acidification and threat to the ecological safety; there are many uncertain factors involved. On the contrary, the invented SFCs capture and fix gaseous CO₂ by photosynthetic reaction from biomass, and stabilize the perishable solid organic carbon as a valued resource on earth for carbon mitigation. SFCs reduce the carbon emission indirectly and slowly, and lead to carbon neutral or even to carbon negative. Production of one ton SFCs, is equivalent to store 500 kg carbon, or fix 1.83 ton CO₂. Production of SFCs is low cost and low tech required. SFCs production and storage are simple and ecologically safe, less oxygen required, without uncertainties. In addition, SFCs are of low-carbon economic values, which will be realized beneficially to reduce the total cost of carbon mitigation. Therefore, SFCs have the advantages of ecological harmony, low cost, low energy consumption, high efficiency, high safety, and no leakage risk. SFCs are more suitable for the globalization of carbon mitigation.

Comparing the primary carbon mitigation effect of the invented SFCs with forestation, their ecological mitigation mechanisms are different; the process costs, energy consumption, safety, efficiency, effectiveness and commercial value are also different. Forestation captures and fixes gaseous CO₂ by photosynthetic reaction on the perennial trees, and stores the gaseous carbon as the solid organic carbon in living trees for carbon mitigation. Carbon mitigation of forestation is proportional to the tree growth rate and life span. Once the trees are dead or flamed by forest fire, their carbon mitigation is lost after the degradation of organic carbon. In addition, large quantities of fallen leaves and branches are produced from forest annually, and the perishable biomass becomes the GHGs emission source. Climate change has increased the risk of fire and diseases for the survival of forest. Forestation relies on the support of land resources. Therefore, forestation is not efficient enough for global carbon mitigation. On the contrary, the invented SFCs capture and fix the already formed carbons from various sources of biomass, such as crop stalks, dead wood, garden waste, fallen leaves and branches from forestation; and stabilize the perishable carbon as a valued economic resource for carbon mitigation. SFCs treatments enable various short-term or long-term resources of biomass to function the same as the living trees for carbon mitigation. Therefore, SFCs achieve more efficient carbon mitigation by comprehensive usage of various bio-resources, compensating the limitations of forestation, and saving land resources. SFCs are more scale feasible, resources feasible, economic viable, ecological viable and technical feasible for global application.

Comparing the invented SFCs with the known arts of activated carbon and biochar from the same biomass resources, their manufacture processes, costs, energy consumption, ecological effectiveness and commercial value are different: 1) Carbon content of SFCs is about 50%, biochar is 70-80%, and activated carbon is 80-90%. SFCs contain less carbon than biochar and activated carbon. 2) SFCs are made in oxidative or oxygen-free conditions of lower temperature (110-350° C.) for short time, biochar is in oxygen-free conditions of higher temperature (350-600° C.) for longer time, and activated carbon is in oxygen-free conditions of high temperature (600-1000° C.). for long time. Manufacturing of SFCs costs far less than that of biochar and activated carbon. 3) The three materials can be made from the same raw biomass, from raw materials to products, the carbon retention ratio of SFCs is 75-99%, biochar is about 50%, and activated charcoal is below 25%. For example, when one ton of dry biomass (carbon content 500 kg, non-carbon content 500 kg) is supplied as the raw material, 750-990 kg of SFCs can be produced, containing about 435 kg carbon, or storing equivalent 1595 kg CO₂; 330 kg of biochar can be produced, containing 250 kg carbon, or storing equivalent 917 kg CO₂; 150 kg activated carbon can be produced, containing 130 kg carbon, or storing equivalent 477 kg CO₂. The carbon and non-carbon resource utilization rate of SFCs is much higher than that of biochar and activated carbon. 4) SFCs have the evident impacts on both primary carbon and non-carbon mitigation, such as nitrogen, sulfur, phosphorus, and heavy metals. During the manufacturing of biochar and activated carbon, large amount of gasified carbons and non-carbons are produced to cause air pollution. 5) There are large carbon loss and pollution emission during the manufacturing process of biochar and activated carbon. In return, the retained carbon in biochar and activated carbon become more stable. The long-term stability of SFCs may not be as good as that of biochar and activated carbon. 6) The hydrophobic characteristics of SFCs is evidently stronger than that of biochar and activated carbon. 7) The sorption capacity of SFCs is evidently higher than that of biochar and activated carbon. SFCs provide wider utilization in environmental protection, such as cleaning oil spills in water, cleaning POPs, and producing high-valued polymer complexes with the scrap plastic or rubber. Thus, although the long-term stability of SFCs may not be as good as that of biochar and activated carbon, the comprehensive advantages of SFCs made them more suitable for the commercialization of global carbon mitigation and the low-carbon economic utilization.

Utilization of SFCs can achieve both advanced eco-friendly carbon and non-carbon mitigation. The invented plant SFCs have various resourceful functions, in addition to the role of carbon sink in the primary carbon and non-carbon mitigation. These functions of SFCs can be utilized to various carbon emission sources and pollution emission sources to achieve advanced carbon mitigation and pollution control on site. During the utilization processes, SFCs maintain the stable carbon skeleton and reduce carbon emission from other sources. After the utilization processes, the used SFCs may be processed as bio-fuels to play a role of carbon neutral; or the used SFCs may be stored or buried to play a role of carbon negative. The invented animal SFC-VIII also achieves the primary carbon and non-carbon mitigation, and the advanced carbon and non-carbon mitigation by its role as the carrier or sorbent.

No. 1 of the resource utilization of SFCs is to function as the capture material, storage medium or biometabolism carrier to control directly the atmospheric GHGs and polluted gases, such as CO₂, CO, CH₄, N₂O, SO₂, formaldehyde, ammonia and other harmful gases. See Examples 12-13, 21, 27 and 39.

SFCs can be utilized for GHGs capture and storage which is based on the mechanism of physical and chemical sorption. The used SFCs are quite stable even they are treated with alkalis or acids for certain time. After the utilization for GHGs capture and storage, the pH value of the used SFCs becomes neutral. The used SFCs are surrounded by the sorbed inorganic salts and become more stable. The used SFCs could be buried, or applied as building materials and fertilizer, or applied to transform saline-alkali soil. The used SFCs have a life expectancy of 40-50 years.

When SFCs are used in GHGs capture and storage, the effectiveness of CO₂ fixation is calculated as follows: Assuming 1 ton of SFCs sorbs 1 ton of CO₂, then for every 100 tons of SFCs, the carbon skeleton itself is equally made of 183 tons of CO₂, and it sorbs and fixes 100 tons of CO₂, a total 283 tons of CO₂ could be fixed in it.

SFCs can also be utilized for GHGs capture and metabolizing which is based on the mechanism of physical sorption, chemical sorption and biometabolism. The aerobic biogroups living in the SFCs carrier are able to decompose the captured GHGs into organic matters or gases with weaker greenhouse effect. For example, on the sites where CH₄ gas is emitted, such as in coalmine, barn and landfill sites, the hydrophobic SFCs could capture the hydrophobic CH₄ gas; and the methane-degrading microbes living on SFCs could further decompose CH₄ into CO₂ and water. The used SFCs have a life expectancy of 5-20 years.

The compressed SFCs or SFCs made from the high-density raw materials such as pine needles, have shown the better capacity of capture and storage for the small-molecule chemicals. Application of these SFCs on GHGs capture and storage is more promising for storage of CO₂, natural gas or hydrogen at lower pressure.

SFCs can also be utilized for GHGs capture which is based on the mechanism of physical sorption, chemical sorption and enzyme catalysis. The high enzyme activities remained in the SFCs carrier is able to transform the captured GHGs into the matters without greenhouse effect. For example, carbonic anhydrase isoenzymes, are able to catalyze the gaseous CO₂ into the liquid bicarbonate. Plant leaves or algae contain plenty of carbonic anhydrase. A large quantity of carbonic anhydrase isoenzymes can be prepared from the cell lysate of plant leaves or algae. The supply of carbonic anhydrase from such sources is both ecological and economical. Both SFCs and carbonic anhydrase are working together to transfer the gaseous CO₂ into the liquid bicarbonate, and further to transfer the liquid bicarbonate into solid calcium carbonate or magnesium carbonate, thereby reducing CO₂ emission. The used SFCs have a life expectancy of 5-20 years.

No. 2 of the resource utilization of SFCs is to function as a component in the composite materials. The composite materials could be used in eco-building and energy-saving fields, such as for insulation materials and sound-sorbing materials; for replacement materials of plastics, wood, steel, cement, asphalt and synthetic materials. It saves material resources, saves energy and stores carbon when the composite materials are used in eco-building construction. It saves more operating energy and reduces emission when the eco-building is in use. See Examples 13-15.

The utilization of SFCs in eco-building is equivalent to store the carbon and to use the carbon resourcefully in buildings. The biggest difference between SFCs and the natural organic carbons in building is that SFCs have the special features of high hydrophobicity and anti-corrosion. The SFCs composites as the heat-preserving and sound-sorbing insulation materials and wall materials, not only preserve the advantageous features of porosity, loose, lightweight, insulation and sorption from the natural organic carbons, but also overcome the drawbacks of damp and perishability due to high hydrophilicity of the natural organic carbons. SFCs composites are characterized by turning wastes into resources. They not only replace the conventional non-renewable raw materials, but also have satisfactory overall performance and cost-effectiveness. To achieve the above features, large quantity of inorganic compounds such as fly ash can be added to the SFCs composites as functional filler to interconnect the porous structure of organic and inorganic minerals; and form a network structure that has the fire-retardant effect. Also large quantity of waste and hydrophobic polymer materials that can be used in SFCs composite materials are plastics (e.g., polypropylene), rubbers, resins (e.g., epoxy resins), paraffin, Vaseline, bitumen, tar, etc. In the SFCs composite materials, the hydrophobic polymer materials have high degree of compatibility with the hydrophobic SFCs, the organic and inorganic materials are interconnected, and a network structure is formed.

After the expansion treatment by conventional techniques, SFCs get more porous structures, and its features and functionality are enhanced, so its utilization in eco-building is more promising.

It is reasonable to believe that the SFCs in the composites with cement and glue as adhesives have a life expectancy of at least 40 years, based on the folk cultural experience of long-term use of adobe brick building made of crop stalks and clay. The SFCs in the composites with plastics or rubber or other hydrophobic polymer materials, have a life expectancy of 50-100 years.

When SFCs are used in energy saving eco-buildings, the fixed CO₂ and energy efficiency are calculated as follows: Assuming that every 1000 square meters floor area require 3000 square meters wall and roof area of insulation materials that have a thickness of 12 cm, and assuming each cubic meter of these materials contains an average of 250 kilograms SFCs, then every 1000 square meters construction area will need 90 tons of SFCs (3000 sqm×0.12 m×0.25 ton) with carbon content of 45 tons (each ton SFCs contains 0.5 ton carbon), an equivalent of 165 ton fixed CO₂ (0.5 ton carbon is equivalent of 1.83 ton CO₂, 45 tons×2×1.83=165 tons). In China for example, the government estimated that 40 billion square meters of non-energy-efficient buildings account for 27.5% of total national energy consumption, and has an ambition to retrofit 13 out of the 40 billion square meters to become energy-efficient buildings that consume only half of the energy as they do today. The retrofitting would require SFCs of 11.7 billion tons, with carbon content of 585 million tons, an equivalent of 2.145 billion tons fixed CO₂. These energy-saving buildings can further lower the total national energy consumption by 4.5% (27.5%×13/40×50%). If the SFCs eco-building technology is implemented worldwide, it is estimated that 5-10 billion tons of CO₂ can be stored in buildings and 3-5% total energy consumption worldwide can be saved.

No. 3 of the resource utilization of SFCs is to make use of their compatibility with common materials and their functionality as the eco-materials, to replace the soft materials of plastic, paper pulp and synthetic fiber; or to replace the rigid materials of plastic, wood, steel and cement. When the eco-materials are manufactured, resources are conserved, energy is saved, carbon is stored and pollution is reduced. When the eco-materials are utilized in a non-destructive manner, additional energy is conserved and pollution is further reduced. See Examples 15-16.

The fibrous, granular, powdered, polymer-like or expanded SFCs are green, environment friendly, loose, thermal insulating, shock sorbing, mildew-resistant and moisture-resistant. These SFCs can be used in filling, packaging, furniture, household, diapers, disposable tableware and other situations that require soft materials.

By adding adhesives, the fibrous, granular, powdered, polymer-like or expanded SFCs can be made into a variety of composite particles, plates and blocks to be used for sorption materials, construction materials, packaging materials, and furniture materials.

The fibrous, granular, powdered, polymer-like or expanded SFCs, when mixed with heat cured with one or more hydrophobic organic carbon materials such as plastics (e.g., polypropylene), rubbers, resins (e.g., epoxy resins), paraffin, Vaseline, bitumen, tar, etc., can be made into a wide range of organic composite materials. The composites have properties of high strength, hardness, toughness, plasticity, high processing performance, water-proofing, acid or alkaline resistance, anti-corrosion, UV proofing, insect resistance, anti-aging, mildew resistant, light weight, non-deformation, non-perishability, no formaldehyde release, easiness to recycle, low cost, and hydrophobicity. The properties of the composites can be changed by adjustment of the quantity proportion between the SFCs and organic carbon materials. The composites can be manufactured to replace plastics, wood, steel, cement, asphalt and synthetic fibers, and to be utilized in gardening, construction, fence piles, decoration, furniture, packaging and other fields. The composites have the following features and advantages: 1. the stability of the carbons stored in SFCs composites is greatly enhanced under the protection of the organic carbon materials, which is in favor of long-term carbon emission reduction. 2. Waste instead of new organic carbon materials such as waste plastics and rubber can be used in the composites, helping solve the “white pollution” and “black pollution”. 3. Due to the good compatibility between the hydrophobic SFCs and hydrophobic organic carbon materials, the manufacturing process of the composites is easy and simplified; a homogeneous mixture of SFCs and organic carbon materials is easily formed without the need of expensive additives. The simple and low cost process is beneficial to the resource industry utilization.

When SFCs are applied as ecological materials, it is appropriate for them to work in conditions where wetness on long-term basis is to be avoided. It is reasonable to estimate that, SFCs in loose soft materials have a life expectancy of 40-50 years; SFCs in fabricated board or block have a life expectancy of more than 50 years; SFCs in hydrophobic organic composites containing plastic or rubber have a life expectancy of 50-100 years.

When SFCs are used in eco-materials, the effectiveness of CO₂ fixation is calculated as follows: 1. as the soft materials or adhesive composites where the SFCs are the only main component, 100 tons of SFCs used are equivalent of 183 tons of CO₂ fixed. 2. SFCs as a part in the composites(for example, 50% in weight), every million tons of composites would use 500,000 tons SFCs out from 550,000 tons of waste biomass, an equivalent of 915,000 tons of CO₂ fixed (1 ton SFCs is equivalent of 1.83 ton CO₂, 500,000 tons×1.83=915,000 tons). At the same time, 500,000 tons of waste organic carbon materials such as waste plastics and rubber are in the composites, an equivalent of 915,000 tons of CO₂ fixed (1 ton waste organic carbon material stores at least equivalent of 1.83 ton CO₂). The composites will save 1.7 million cubic meters of lumber; or save 4 million tons of cement or steel; or save 500,000 tons of plastics and aluminum, respectively.

No. 4 of the resource utilization of SFCs is in soil management in eco-agriculture and eco-prataculture. The SFCs as carbon carriers increase the content of stable organic carbon in soil, and function as the soil improvement material, sorption material, pest-resistant material, sustained-release carrier material and eco-fertilizer carrier. SFCs in soil reduce GHGs emission, reduce chemical pollution by applying less pesticide and chemical fertilizer, and help conserve biological diversity. See Examples 8, 17, 21-22, and 26-27.

Taking the advantage of high sorption capacity for chemical pollutants such as pesticides, POPs, heavy metals, etc., the SFCs can be evenly applied by tillage into the chemically polluted agricultural farmland. The applied SFCs are able to sorb and fix the pollutants; block the transferring path between pollutants and growing crops; and further prevent the pollutants from reaching growing crops. Particularly, the hydrophobic lipophilic SFCs have strong affinity and sorption for POPs that are strong hydrophobic lipophilic and hard to be degraded in soil, and therefore play a special role in the reduction of harmful and highly lipophilic organic pollutants. The contaminated plants from the contaminated soil after conventional bioremediation can also be stored securely as the SFCs products.

Taking the advantage of SFCs' loose and porous nature and their affinity to microorganisms and organisms, SFCs can be tilled into farmland or grassland to improve soil carbon storage, ventilation, water and fertilizer retention. SFCs provide the beneficent soil microorganisms with an excellent hosting environment for growth and development. The SFCs mechanism protects the biodiversity; promotes the soil natural ecosystem, fertility and its ability of rehabilitation and restoration; hence lessens the need for chemical fertilizers and pesticides. It reduces emission of GHGs such as nitrous oxide. Due to SFCs' sorption capacity and carrier capacity for chemical fertilizers or pesticides, the SFCs that are pre-soaked with chemical fertilizers and pesticides can be tilled into farmland, playing a role of sustained-release tool, also lessening the need for chemical fertilizers and pesticides.

A pyramid greenhouse made of plastic mulch can reduce pests and diseases, and lessen the need for chemical fertilizers and pesticides. The hydrophobic SFCs, when mixed and cured with waste plastic mulch which is abandoned in great amount after being used in agricultural production, can produce a new composite, helping solve the pollution problem of agricultural plastic mulching.

The long-term stability of the SFCs may be adversely affected when they are applied in ecological agriculture, as a result of long-term burying in the soil under wet condition. It's estimated that SFCs in the soil have a life expectancy of 20-50 years.

After the pollution cleanup, SFCs carry large amount of pollutants. Anaerobic microorganisms can be introduced and turn the pollutants into new energy source CH₄, or earthworms introduced to produce organic fertilizer.

When SFCs are used in ecological agriculture, the efficacy of CO₂ fixation is calculated as follows: Assuming 10-20 tons of SFCs are applied in each hectare (15 acres) of farmland, then each hectare farmland would use 10-20 tons of SFCs, with 5-10 ton of carbon, an equivalent of 18.3-36.7 tons CO₂ fixed. In China for an example, assuming that 50% of its 1.8 billion acres (0.06 billion hectares) farmland are retrofitted with SFCs, then total SFCs used would be 0.6-1.2 billion tons, with carbon content of 0.3-0.6 billion tons, an equivalent of 1.1-2.2 billion tons of CO₂ fixed. Assuming the SFCs technologies in ecological agriculture is implemented on a global scale, 5-10 billion tons of CO₂ is expected to be stored.

No. 5 of the resource utilization of SFCs is in ecological farming for livestock, poultry and aquaculture. The SFCs are used as the fodder additives and pollution sorption materials to combat increasingly serious pollution problem through SFCs mediated ecological detoxification, ensuring food safety for humans. Animal excretion containing both SFCs and SFCs-sorbed contaminants can be turned into CH₄ energy source and organic fertilizer and put back to the eco-agriculture. See Examples 9-11.

Taking the advantage of their physical sorption, chemical sorption, microbe carrying ability, drug sustained-release ability, and hardness in digestion by non-herbivorous animals, the SFCs mixed with conventional fodder can be fed to non-herbivorous livestock, poultry and aquatic products. The SFCs can sorb variety of toxins and chemical pollutants taken in by the animals through fodder, water and breathing such as dirty oil, pesticides, toxic organic compounds, heavy metals and so on. Then the SFCs sorbed with toxins and chemical pollutants will be excreted as feces because the SFCs can not be easily digested by the non-herbivorous animals. Particularly, the hydrophobic lipophilic SFCs have strong affinity and sorption capability for highly hydrophobic lipophilic POPs such as dioxins and highly toxic substances such as aflatoxin that are easily accumulated in animal organs, hence play a special role in the reduction of harmful and highly lipophilic organic pollutants such as POPs and aflatoxin. This technique can prevent or reduce sorption by animals the chemical pollutants taken in through fodder, water and breathing; also help discharge chemical pollutants accumulated previously, hence produce less polluted, high quality and high yield meat, dairy and egg products at low cost.

In eco-farming, SFCs staying time in the acid and enzymatic environment of animals' digestive tract is short; therefore the stability of SFCs structure is only slightly affected. The fed SFCs are discharged out of the body with feces. SFCs mixed with feces can be anaerobically fermented to produce ecological and clean energy CH₄, can also be digested by the earthworms to make bio-organic fertilizer for eco-agriculture. The used SFCs after ecological farming have a life expectancy of 20-50 years.

No. 6 of the resource utilization of SFCs is in ecological environment protection and ecological clean energy. Taking the advantage of their physical sorption, chemical sorption and biological sorption, the SFCs can be the sorbents and carriers for pollutants, microbes or other organisms. The SFCs collect and trap pollutants; clean up the environment and reduce GHGs pollution; and microbes in the SFCs break down the captured pollutants into a new energy source CH₄ or organic fertilizer for ecological agriculture. See Examples 17-27, 35 and 38.

SFCs are integrated with many physical and chemical functionalities such as physical sorption, chemical sorption, porous structure, large surface area, affinity effect, filtration, molecular sieve, membrane, carrier and other features. Therefore, SFCs can substitute for the well-known sorbent activated carbon to clean various pollutants.

Particularly, SFCs can form the chemically modified complex with boric acid and reducing sugars. When boric acid, reducing sugars and SFCs are mixed together, boric acid form a reversible bonding with the adjacent cis-hydroxyl groups of reducing sugars and SFCs, so a molecular sieve layer can be formed on the surface of SFCs. The modified complex can be used for storage of chemicals or removal of chemical contaminants and heavy metal ions from fluids.

On the other hand, the biological attraction of SFCs for beneficent microorganisms and beneficent organisms is very conducive to biodiversity and adaptability. SFCs, as the natural biocarriers, could overcome the well known drawbacks in existing inorganic carriers and organic synthetic carriers for microbes; could improve carriers' sorption and retention capacities for pollutants; could increase the oxygen concentration at the three-phase mediated by SFCs; and could provide a suitable environment for the biological decomposition mechanism. The SFCs biocarriers and their equipment designs are characterized by the maximal oxygen supply to the aerobic microbes and organisms from minimal energy supply, without the limit of a conventional energy-intensive aeration system.

The physical, chemical and biological methodologies are integrated in the SFCs-microbes bioreactor, so that the pollutants from fluid are sorbed and concentrated into the SFCs through SFCs' physical sorption and chemical sorption, then the concentrated pollutants are further decomposed and metabolized by microorganisms that are sorbed and lodged ecologically in the SFCs, enhancing the cleaning efficiency.

Particularly, the SFCs-microbes bioreactor has a good capture and cleaning effect on the suspended particles in atmosphere such as fine particulate aerosols, which have serious impact on climate change and healthy environment. Therefore, SFCs can play a role in reducing aerosol pollution and lessen aerosol's impact on climate change.

Particularly, both sewage water and exhaust gas can be cleaned simultaneously by the SFCs mediated two-step cleaning route. For example, the sewage water and exhaust fumes from catering industry are treated in an integrated cleanup. The first step is using SFCs mediated sewage water to cool and rinse the hot exhaust fumes; transferring the gaseous pollutants in exhaust fumes into the liquid pollutants in sewage water; getting, the cleaned air out; and getting the even worse sewage water. The second step is applying SFCs mediated sorption to catch and accumulate the hydrophobic pollutants from the even worse sewage water; using the aerobic microbes to decompose and clean the hydrophobic pollutants on SFCs; finally discharging or recycling the cleaned water. If not decomposed by microbes, the collected hydrophobic pollutants can be used for preparation of bio-diesel.

After the cleanup of industrial, agricultural and domestic pollution, the SFCs have sorbed and trapped a great number of pollutants. If the complex of SFCs-pollutants is treated with the anaerobic microbes, biogas containing CH₄ can be produced from it. In the landfill site, landfill gas containing CH₄ can be produced naturally as a result of anaerobic degradation of refuse. Both collected biogas and landfill gas have great potential for application as fuel, but often contain a higher concentration of ammonia, hydrogen sulfide and other harmful gases, limiting the application. The SFCs chemical sorption cleaner is able to remove harmful gases such as ammonia and hydrogen sulfide from biogas or landfill gas. Therefore, SFCs can play a key role in controlled production of the clean energy source CH₄.

The long-term stability of the SFCs may be adversely affected when they are applied in ecological environment protection and clean eco-energy, as a result of long-term chemical treatment, microbial decomposition, earthworms' breakdown, enzymes breakdown, moisture, oxygen-rich or anoxic environment. SFCs in these areas are expected to last for 5-20 years.

When SFCs are used in ecological environment protection and clean eco-energy, the efficacy of CO₂ fixation is calculated as follows: Assuming the functions of SFCs last for long time; and 1 ton SFCs can sorb and treat a total of 100 tons of carbon-containing pollutants that are subsequently decomposed and turned into 30 tons of CH₄, then every 100 tons of SFCs contains equivalent of 183 tons of CO₂ fixed, and is able to clean 10,000 tons of carbon-containing pollutants which may produce 3,000 tons of clean energy CH₄.

No. 7 of the resource utilization of SFCs is in cleaning of eutrophic water bodies, fixing of atmospheric CO₂, and producing of new eco-energy and new resources. See Example 21.

Flowing into the nature without being fully treated, domestic sewage, industrial and agricultural wastewaters cause the eutrophication of water bodies. The proper usage of eutrophic water bodies in man-made local loops of open waters or bioreactors can foster fast-growing of photosynthetic autotrophs such as algae, water hyacinth and photosynthetic bacteria at high-density. The gas-liquid exchange system of SFCs, on the other hand, supplies both dissolved oxygen and dissolved CO₂ from CO₂ polluted air for the water bodies and photosynthetic autotrophs. Photosynthetic autotrophs not only sorb large amount of carbon, phosphorus, nitrogen and other elements from the eutrophic water, reduce the GHGs released from natural decomposition of eutrophic water, but also sorb large amount of CO₂ from atmosphere or industrial emission. The technique results in the cleaning of eutrophic water bodies, reduction of atmospheric CO₂, reduction of GHGs emission, and the harvested photosynthetic autotrophs material for SFCs, bio-fuel, fodder and organic fertilizer. The harvested photosynthetic autotrophs material can also be the donor of carbonic anhydrase to lower the atmospheric CO₂ by SFCs-enzyme method. Water bodies cleaned initially by photosynthetic autotrophs can undergo the SFCs-microbes process for further deeper cleaning.

Light, temperature, nutrition, pH and air exchange, etc., are the main parameters required to grow photosynthetic autotrophs such as algae for water cleaning. The biggest known problems are how to supply the photosynthetic autotrophs with the sufficient dissolved oxygen and dissolved CO₂, and how to separate timely the matured photosynthetic autotrophs and their seeds from the cleaned water. In order to enhance the synthetic efficiency and to avoid the toxin released from newborn and decomposed dead organisms back to the cleaned water, a specific SFCs carbon emission reduction system is designed, the cleaning is processed as follows: (1) SFCs gas-liquid exchange system provides dissolved oxygen and dissolved CO₂ for water cleaning and photosynthetic autotrophs; (2) SFCs filtration system rapidly and efficiently separates the photosynthetic autotrophs from the initially cleaned water; (3) Water bodies cleaned initially by photosynthetic autotrophs undergoes the SFCs-microbes process for further deeper cleaning.

No. 8 of the resource utilization of SFCs is in medicinal and public health care fields, used as drug detoxification, drug sustained-release, healthy food, indoor air cleaning, electromagnetic field (EMF) protection, etc. See Examples 27-30, 32-33.

SFCs have the properties of inert, ecological safety, physical sorption, chemical sorption, controlled sustained-release as drug carriers, hardness to digest by human bodies. The food-grade SFCs can be taken orally by humans. While not being sorbed through gastrointestinal tract into the body, SFCs sorb in the tract a lot of toxins and chemical contaminants that are taken in with food, water and breathing, such as petroleum, pesticides, toxic organics, heavy metals and so on; and SFCs with the sorbed contaminants will be excreted as SFCs can not easily be digested and sorbed by the body. Particularly, the hydrophobic lipophilic SFCs have strong affinity and sorption for the strongly hydrophobic lipophilic and highly toxic contaminants that are easily accumulated within human body, therefore play an effective detoxification. Another example, after alcohol drinking, SFCs taken orally can effectively reduce the blood alcohol content.

A SFCs bioreactor (FIG. 6) can be designed and used for air and wastewater cleaning based on SFCs' features of physical sorption, chemical sorption, and the loose porous biomedium for living organisms. Polluted water or air is introduced into the three-dimensional ecological cleaning system that is composed of SFCs composite, plant roots, microbes, earthworms, fungi, protozoa, micro-metazoan and above-ground plant parts. Pollutants, along with moisture and nutrients, are physically and chemically sorbed and concentrated in the SFCs; then decomposed and metabolized by plant roots, microbes, earthworms, other organisms and the above-ground plant parts, under the aerobic condition of good lighting and ventilation. Air or water is cleaned through physical, chemical and biological restorations. The invention has created a well ventilated, humid and aerobic environment, which is conducive to the growth of plants, microbes, fungi, protozoa, micro-metazoan and earthworms; beneficial to the development of plant roots and great increase in the gas-liquid exchange rate; and favorable to the sorption of plant roots for gaseous pollutants. Cleaning functionalities of the system to gaseous, liquid and solid pollutants are further enhanced by using the bioactive substances such as the SFCs, plant roots, active root exudates, root microorganisms, SFCs microorganisms, fungi, protozoa, micro-metazoan and earthworms. Upper part of plants such as leaves is also used to clean gaseous pollutants. The cleaning ability of the system is dependent on SFCs, plant species, roots, root density, light, time, pH, type and concentration of pollutants. Among these factors, a better choice is the mixed planting of strong taproot system plants and fibrous root system plants, and the plants that have tolerant and decomposing abilities to the toxic pollutants. Large numbers of green plants that can be used are aloe, ivy, tequila, chlorophytum, chrysanthemums, cactus, asparagus and other vines, ferns, cactus categories of ornamental plants. According to various needs, the SFCs composite may be prepared proportionally with the hydrophobic oleophilic SFCs that mainly have sorption function, the alkali hydrophilic SFCs that mainly have pH adjusting and water-retaining functions, and other loose porous medium plus a small amount of nutritional soil. Featuring healthy-living, energy-saving and green ornamental planting, the SFCs bioreactor can clean up the air and water simultaneously (FIG. 7). Firstly, water is cleaned at lower parts of the bioreactor through SFCs, plant root system, microorganisms under anaerobic or aerobic condition; then air is cleaned at the mid-to-upper parts of the bioreactor through SFCs, plant root system, microorganisms, and earthworms under aerobic condition. When it is used for indoor or outdoor air cleaning, the SFCs bioreactor can simultaneously remove volatile organic compounds (VOCs), exhaust gas, fog haze, CO₂, CO, cigarette smoke, kitchen fume, odor, ozone, dust mites, pollen, aerosols, heavy metals, microorganisms; generate oxygen and air negative ions; moisturize the air; promote green watch with ornamental plants. It can also save air-conditioner energy consumption by cooling the air; reduce sick building syndrome. When UV light or other sterilization equipment is supplied at the air inlet, the bioreactor's feature of pathogenic microorganism sterilization can be further enhanced. If the bioreactor is covered by a pyramid greenhouse, the activities of organisms and abilities of pollution decomposition can be further enhanced.

The SFCs-mediated anaerobic/oxidative water bioreactor can effectively kill disease-causing microorganisms in the water, such as bacteria, spores, viruses, fungi and so on. The system consists of the two steps of SFCs anaerobic and SFCs aerobic treatments. The SFCs anaerobic treatment can sorb, filter, suppress and kill the aerobic pathogenic microorganisms such as Legionella in anoxic environment. And the SFCs aerobic treatment can sorb, filter, suppress and kill the aerobic and anaerobic pathogenic microorganisms such as Salmonella in ozone-containing oxidative environment.

A complex can be made by mixing SFCs with zero-valent iron powder. The composite has the functionalities of electrostatic protection, electromagnetic shielding, radiation protection, chemical sorption and catalytic decomposition, for indoor and outdoor uses.

A complex can be made by mixing SFCs with chitosan. Chitosan is the derivative product of chitin from arthropods and insects, after the removal of acetyl group. It is a positively charged cationic animal cellulose with free amino groups on the structure. The SFCs from plant cellulose and chitosan from animal cellulose, have both good physical compatibility and functional complementation. Preliminary experiments showed that the complex of SFCs and chitosan can effectively remove microorganisms, colloidal particles, organic matter and heavy metal ions from fluid pollution; remove fat, fat-soluble toxins and heavy metals from human and animal bodies; can be used for radiation protection.

Among all types of SFCs, the SFC-V, VI and VII are, functioning the best in the medical and health care applications. After undergoing a two-type thermo-chemical treatment, the SFC-V, VI or VII, has evidently strengthened properties over that of the SFC-I, II, III or IV that are undergone only one type of thermo-chemical treatment. The properties include long-term oleophilic hydrophobicity, chemical stability, resistance to biological oxidation and decomposition, ecological safety, odor removal, taste and sorption capability.

No. 9 of the resource utilization of SFCs is in solid waste cleaning, reducing pollution by natural anaerobic fermentation, eco-organic fertilizer production and delivery of bio-protein. See Examples 37-38.

Usage 1: After the cleanup of industrial, agricultural and domestic pollution, the SFCs have sorbed and trapped a great number of pollutants. If the complex of SFCs-pollutants is treated with the microbes, earthworms, fungi, protozoa and micro-metazoan, the post-processing and utilization are realized. SFCs provide the organisms with a loose breathable environment to live, and supply the organisms with a large number of sorbed pollutants as food. SFCs become powerful media to help the organisms transform pollutants into eco-organic fertilizer.

Usage 2: The fermented garbage, feces, sludge of sewage treatment, or biodegradable waste can be mixed with the SFCs to form a loose mixture. The mixture is put into a SFCs bioreactoi (FIG. 6), then, earthworms, aerobic microorganisms and plants are introduced. Fungi, protozoa and micro-metazoans may naturally grow in this environment. The loose and breathable oxygen-enriched moist environment mediated by SFCs, provide a suitable living condition and a large number of sorbed pollutants as food for earthworms and other organisms. The pollutants are degraded rapidly into the eco-organic fertilizer with the help of various microbes and enzymes living in the digestive tract of earthworms. The production of earthworms' body can be a supply of pharmaceutical raw materials or concentrated feed protein. The SFCs-mediated system provides sufficient oxygen and air permeable condition for the biodecomposition of bio-degradable garbage, thus, reduces CH₄ and odor emission greatly from the natural anaerobic fermentation process of garbage. In addition, the system is able to discharge timely a small number of harmful gases for earthworms which were produced in the decomposition, such as CO₂, CH₄, ammonia and hydrogen sulfide.

Usage 3: The fermented carbohydrates or garbage can be mixed with the SFCs and a small amount of humus to form a loose mixture. The mixture is put into a SFCs bioreactor (FIG. 6), then, yeast is introduced. Aerobic microorganisms, fungi, protozoa and micro-metazoans may naturally grow in this environment. The loose and breathable oxygen-enriched moist environment mediated by SFCs, provides a suitable living condition and a large number of sorbed pollutants as food for the yeast and other organisms. The pollutants are degraded rapidly into the eco-organic fertilizer and yeast protein. The SFCs-mediated system provides sufficient oxygen and air permeable condition for the biodecomposition of bio-degradable garbage, thus, reduces CH₄ and odor emission greatly from the natural anaerobic fermentation process of garbage. In addition, the system is able to discharge timely a small number of harmful gases for yeast which were produced in the decomposition, such as CO₂, CH₄, ammonia and hydrogen sulfide.

Usage 4: The crushed garbage can be mixed with the SFCs and a small amount of humus to form a loose mixture. The mixture is put into a SFCs bioreactor (FIG. 6), then, aerobic microorganisms, yeast, hydrolytic enzymes, earthworms, fungi, protozoa and micro-metazoans are introduced. Particularly, the circulation of garbage leachate, provides long-term wet condition for the bioreactor. Municipal solid waste and garbage leachate are degraded rapidly, and CH₄ or odor emission is reduced greatly.

No. 10 of the resource utilization of SFCs is in achieving energy-saving while reducing emission. See Example 40.

Based on the SFCs' feature of air permeability without a strong power-driving force, the polluted air can be driven through the SFCs bioreactor by the differences of air pressures and density of exhaust gas at different temperatures from a chimney of certain height, without consuming electricity. For every 1 meter rise, the atmospheric pressure is reduced by about 10 Pa. 50-500 Pa motivation of pressure difference is generally enough to drive the SFCs cleaning facilities. The chimney can be built on the top of a building or mountain. The solar-heated polluted air or hot industrial emission is introduced from the bottom of the chimney. There are differences of pressure and temperature between the top and bottom of chimney, driving the polluted air from bottom to top. The SFCs bioreactor at the top of chimney cleans the air and discharge.

No. 11 of the resource utilization of SFCs is in achieving advanced eco-friendly non-carbon mitigation while reducing carbon emission, such as nitrogen mitigation from cleaning of eutrophic sewage, from cleaning of garbage leachate, or from cleaning of vehicle exhaust. See Example 41.

The SFCs-mediated nitrogen mitigation can be the biological denitrification process, including two steps. The first step is the bio-nitrification, with the nitrification bacteria and oxygen-enriched SFCs involved in alkaline environment, ammonia and nitrogen oxides in the polluted fluid are oxidized into water-soluble nitrite and nitrate; at the same time, the organic carbon sources are oxidized and degraded. The second step is the bio-denitrification, where nitrate is reduced into molecular nitrogen with the denitrifying bacteria attached on SFCs under anaerobic condition. The bio-denitrification requires the support of carbon source, which may come from the organic carbon in post-nitrified water. While the organic carbon is not sufficient in the post-nitrified water, external carbon source or sewage without nitrification is supplemented. The post-denitrified water can be returned to the bio-nitrification reactor. While the organic carbon is sufficient in the sewage, denitrification can be the first step, and nitrification be the second one. The post-nitrified water can be returned to the bio-denitrification reactor.

The SFCs-mediated nitrogen mitigation can also be the combination of biological denitrification and chemical denitrification, including three steps. The first step is the bio-nitrification, with the nitrification bacteria and oxygen-enriched SFCs involved in alkaline environment, ammonia and nitrogen oxides in the polluted fluid are oxidized into water-soluble nitrite and nitrate; at the same time, the organic carbon sources are oxidized and degraded. The second step is the bio-denitrification, where nitrate is reduced into molecular nitrogen with the denitrifying bacteria attached on SFCs under anaerobic condition. The bio-denitrification requires the support of carbon source, which may come from the organic carbon in post-nitrified water. While the organic carbon is not sufficient in the post-nitrified water, external carbon source or sewage without nitrification is supplemented. The post-denitrified water can be returned to the bio-nitrification reactor. The third step is the chemical catalytic denitrification, with the mixture of SFCs and the redox catalyst zero-valent iron powder involved in anaerobic, lack of carbon source and acidic environment, the residual nitrate from bio-denitrification is reduced into molecular nitrogen or ammonia nitrogen and is discharged later. The discharged gas can be returned to the nitrification reactor for cycled cleaning. The additional chemical catalytic denitrification step improves the overall cleaning efficiency of nitrogen emission without the carbon support, avoids the secondary pollution and reduces the processing costs.

The SFCs-mediated nitrogen mitigation can also be done by another way of procedure order, including three steps. The first step is the bio-denitrification, nitrate is reduced into molecular nitrogen with the denitrifying bacteria attached on SFCs under anaerobic condition, while the carbon source in sewage is also cleaned. The second step is the chemical catalytic denitrification, with the mixture of SFCs and the redox catalyst zero-valent iron powder involved in anaerobic, lack of carbon source and acidic environment, the residual nitrate from bio-denitrification is reduced into molecular nitrogen or ammonia nitrogen and is discharged later. The third step is the chemical catalytic nitrification, with the mixture of SFCs and the redox catalyst manganese dioxide involved in aerobic and pH neutral environment, ammonia and nitrogen oxides from polluted air or from chemical catalytic denitrification are oxidized into water-soluble nitrite and nitrate; and the effluent is returned to the bio-denitrification reactor. In the chemical catalytic process, the water-insoluble manganese dioxide is reduced to divalent manganese, and oxidized back to manganese dioxide by oxygen. The third step could also be the bio-nitrification, with the nitrification bacteria and oxygen-enriched SFCs involved in alkaline environment, ammonia and nitrogen oxides from the polluted fluid or from chemical catalytic denitrification are oxidized into water-soluble nitrite and nitrate; at the same time, the organic carbon sources are oxidized and degraded. The effluent can be returned to bio-denitrificaton reactor for cycled cleaning.

No. 12 of the resource utilization of SFC-VIII is to store food, seeds and contaminated animal sources in the pyramid warehouse at room temperature and other easily achieved conditions, in order to reduce pollution emission, energy-saving and to reduce electromagnetic pollution. See Example 42.

By the dehydration process of SFC-VIII preparation, animal or plant proteins can be long-term reserved at room temperature in the low-powered pyramid. The reserved proteins can be the strategic reserves or supply sources of food and seeds, such as the soybean and peanut reserves, in order to cope with food shortages and catastrophic climate change events.

When the animal and plant materials are contaminated, such as from pollution, poisoning and after-use of pollution cleanup, they contain hardly-biodegradable and toxic organic pollutants such as POPs, pesticides, or contain toxic inorganic pollutants such as heavy metals; therefore should not be used as food or fodder, nor allowed to leach the pollutants by the natural degradation. SFC-VIII may be prepared from the contaminated organisms for long-term storage, thereby reducing pollution re-emission.

The pyramid warehouse that is built with SFCs and where reserved SFCs are stored, may sorb and clean the electromagnetic pollution of the environment.

### BRIEF DESCRIPTION OF THE DRAWING

FIG. 1. Principle of systematic carbon mitigation. GHGs pool D which causes the greenhouse effect 5 comes mainly from the atmospheric carbon pool A. Land and sea-based carbon pool B is formed from carbon pool A by the carbon fixing processes 1 of photosynthesis and dissolution, a large quantity of carbon resources is stored in carbon pool B. Carbon pool A is regenerated from carbon pool B by the degradation processes 2 of respiration, combustion and microbial decomposition. A carbon cycle or carbon balance is formed between carbon pool A and carbon pool B, leading to carbon neutral. Underground and stable carbon sink C is, formed from carbon pool B through a very slow geological process 10. Carbon sink C is exploited by humans, its degradation 3 adds carbon pool A, and degradation 4 adds carbon pool B and carbon pool A, finally GHGs pool D is increased, leading to carbon positive. Carbon sink E is formed from the unstable, biodegradable carbon resources in carbon pool B by treatments 6 of thermo-chemical process. Represented as SFCs, the carbon products in carbon sink E are relatively stable and anti-biodegradable, reducing both the total amount of cycled carbon and the cycling speed, reducing both the content of GHGs pool D and greenhouse effect 5, leading to carbon negative. Carbon sink F is formed from carbon sink E through a carbon resourceful process 7. Carbon sink F is utilized functionally to reduce the contents of carbon pool A and carbon pool B through a carbon resourceful process 11, and to reduce further the content of GHGs pool D and greenhouse effect 5, not only keeping the carbon negative, but also contributing the collected carbon resources to the low-carbon economy. Carbon sink G is formed from carbon sink E and carbon sink F after utilization through a storage process 9, keeping the long-term carbon negative. Carbon sink E, carbon sink F and carbon sink G return slowly by degradation 8 to carbon pool A and carbon pool B.

FIG. 2. Preparation of SFC-II or SFC-III. The convection oven 2 has heating element 6 (or microwave element 6) and fan 4. The oven 2 is equipped with an open sample reaction container 14 to support sample 8. Sample 8 is covered by silicon sands or iron sands 12. Inlet 10 allows air to enter, and outlet 22 allows the released gases to escape after the condenser 18 and the air cleaner 20.

FIG. 3. Preparation of SFC-IV. Convection heating roller 2 is rotated on the axis 4. Heating element 6 at the outer roller heats sample 8 inside roller 2. Inlet 10 allows the heated oxidative medium to enter roller 2 and react with sample 8. Outlet 22 allows the dust, moisture and volatile materials which are produced from the heated and oxidized sample 8 to escape via sequential passages of roller opening 12, gas collector 14, dust collector 16, condenser 18 and air cleaner 20.

FIG. 4. Utilization of SFCs for aerobic dual cleaning of polluted water and air. Dual cleaning equipment 2 includes sewage cleaning compartment 1, air cleaning compartment 3 and air blower 8. The following partitions are with dense holes, including side-partition 10, side-partition 12 and under-partition 14 of sewage cleaning compartment 1; and side-partition 16, side-partition 18 and under-partition 20 of air cleaning compartment 3. SFCs 22 are loaded on the under-partition 14 and under-partition 20, respectively. Aerobic microorganisms 24 are introduced into SFCs 22, other living organisms could grow naturally on SFCs 22 later. Polluted water is added to the top 32 of sewage cleaning compartment 1, passing and getting cleaned by SFCs 22 and aerobic microorganisms 24, then the cleaned water is discharged from under-partition 14. Air blower 8 allows the external fresh air to enter sewage cleaning compartment 1 via side-partition 10, supplying oxygen to aerobic microorganisms 24. Fresh air and the gases produced from sewage cleaning compartment 1 enter air cleaning compartment 3 via side-partition 12, air blower 8 and side-partition 16, cleaned by SFCs 22 and aerobic microorganisms 24, then discharged via side-partition 18. Water and nutrition for SFCs 22 and microbes 24 in air cleaning compartment 3 are added to top 33, discharged via under-partition 20.

FIG. 5. Utilization of SFCs for anaerobic cleaning of polluted water. Sewage bioreactor 2 is composed of a number of successively declining compartments 1, 3, 5, 7. Each compartment has a perforated under-partition 14 to support SFCs 22 and anaerobic microorganisms 25. Polluted water is added to the inlet 32, up flowed through under-partition 14 into compartment 1, passing and getting cleaned by SFCs 22 and anaerobic microorganisms 25 in compartment 1, then entered the sequential compartment 3, 5 and 7 by water pressure for further cleaning, finally discharged from outlet 34. Each compartment has a sealed space 40, forming the anaerobic environment. The produced methane in the anaerobic process is collected by pipeline 38.

FIG. 6. Utilization of SFCs for air cleaning or garbage decomposition. SFCs 22 (or a mixture 22 of SFCs and solid garbage) is loaded on the perforated under-partition 14 of air bioreactor 2. Plants 26, aerobic microorganisms or yeast 24 and earthworms 28 are introduced into SFCs 22, other living organisms could grow naturally on SFCs 22 later. Supply plants 26 with light 42. Air bioreactor 2 is composed of SFCs 22, above ground parts of plants 26, roots and root active secretion 27, aerobic microorganisms or yeast 24 and earthworms 28. Polluted air is introduced into air bioreactor 2 from bottom 3 via air blower 8 or chimney 8, coarse chemical sorption filter 46 and UV lamp 44. Cleaned air is released upward from top 1. Water and nutrients for the bioreactor are added to top 1, and discharged via under-partition 14 and outlet 34. For treatment of mixture 22 of SFCs and solid garbage, organic fertilizer could be formed after digestion by aerobic microorganisms or yeast 24 and earthworms 28.

FIG. 7. Utilization of SFCs for air cleaning and water cleaning. SFCs 22 is loaded in air cleaning and water bioreactor 2. Perforated side-partitions 10 are placed at air inlet 36, air outlet 38, water inlet 32 and water outlet 34. Plants 26, aerobic microorganisms 24, anaerobic microorganisms 25 and earthworms 28 are introduced into SFCs 22, other living organisms could grow naturally on SFCs 22 later. Supply plants 26 with light 42, and a sealed greenhouse is formed on top 48. Air cleaning part of bioreactor 2 is composed of SFCs 22, roots and root active secretion 27, aerobic microorganisms 24 and earthworms 28. Polluted air is introduced into air cleaning part of bioreactor 2 from air inlet 36 via air blower 8 and perforated side-partition 10, and cleaned air is released from air outlet 38. Water cleaning part of bioreactor 2 is composed of SFCs 22, roots and root active secretion 27 and anaerobic microorganisms 25. Polluted water is introduced into water cleaning part of bioreactor 2 from water inlet 32, and cleaned water is released from water outlet 34. Water and nutrients for the upper part of bioreactor are added from top 48, and collected at outlet 34.

FIG. 8. Utilization of SFCs for air cleaning of suspended particles. SFCs 22 is loaded on the perforated under-partition 14 of air bioreactor 2. Aerobic microorganisms 24 are introduced into SFCs 22, other living organisms could grow naturally on SFCs 22 later. Air bioreactor 2 is composed of SFCs 22 and aerobic microorganisms 24. Air with suspended particles is introduced into air bioreactor 2 from air inlet 36, and cleaned air is released by air blower 8. Some collected particles are removed by scraper 50. Spray water and nutrients 33 are added from top, and collected at outlet 34.

FIG. 9. Utilization of SFCs for sewage cleaning of suspended particles. Sewage cleaner is composed of two declined compartments 1 and 3. Each compartment has a perforated under-partition 14 to support SFCs 22. Polluted water is added to the inlet 32, up flowed through under-partition 14 into compartment 1; the particles get filtrated by SFCs 22 and accumulated underneath under-partition 14; the microbes 24 from polluted water stay and grow in SFCs; the pollutants are sorbed and biodegraded by SFCs 22, microbes 24 and aquatic plants 26 in compartment 1; the rest of water enter the sequential compartment 3 by water pressure for further cleaning; finally the cleaned water is discharged from outlet 34. Some accumulated solid particles are removed by scraper 50, and collected via gate 35.

FIG. 10. Utilization of SFCs for oil or hydrocarbon contaminated sewage. Sewage cleaner is composed of filtration/sorption compartment 1 and sorption/biodegradation compartment 3. Polluted water is added from inlet 32 into the “Z” shaped filtration/sorption compartment 1 where SFCs 22 is loaded on the sloped passage 54 and covered by plate 52. Oil and hydrocarbon are sorbed into SFCs 22. Change new SFCs 22 when they are saturated. The cleaner water enters the sorption/biodegradation compartment 3 via inlet 33 for further cleaning. SFCs 22 are loaded inside the perforated side-partition 10, side-partition 12 and under-partition 14 of sorption/biodegradation compartment 3. Aerobic microorganisms 24 are introduced into SFCs 22, other living organisms could grow naturally on SFCs 22 later. Pollutants are sorbed and biodegraded by SFCs 22 and aerobic microorganisms 24, and cleaned water is released from outlet 34 via under-partition 14. Fresh air for aerobic microorganisms 24 is introduced into sorption/biodegradation compartment 3 via side-partition 10, and released via side-partition 10 and air blower 8.

FIG. 11. Utilization of SFCs for CO₂ capture by enzymatic treatment. A mixture of SFCs 22 and carbonic anhydrase solution 30 is loaded on the perforated under-partition 14 of air bioreactor 2. CO₂ air is introduced from inlet 36 into air bioreactor 2. Gaseous CO₂ is transferred to liquid bicarbonate after the catalysis of carbonic anhydrase 30. The cleaned air is released from outlet 38 via air blower 8 on top of the air bioreactor 2. Spray solution 33 which contains carbonic anhydrase, pH 6-9, is introduced from the top to add the fresh carbonic anhydrase activity on SFCs 22, and to wash off the accumulated bicarbonate. Liquid bicarbonate is collected in pool 56 via passage 31, then transferred to sink 58 via passage 33. Ca²⁺ or Mg²⁺ or Fe²⁺ or Mn²⁺ is introduced into sink 58 to form solid carbonate salts with liquid bicarbonate. Solid carbonate salt is removed via gate 35. Supernatant is expelled via outlet 34 or return to be spray solution 33.

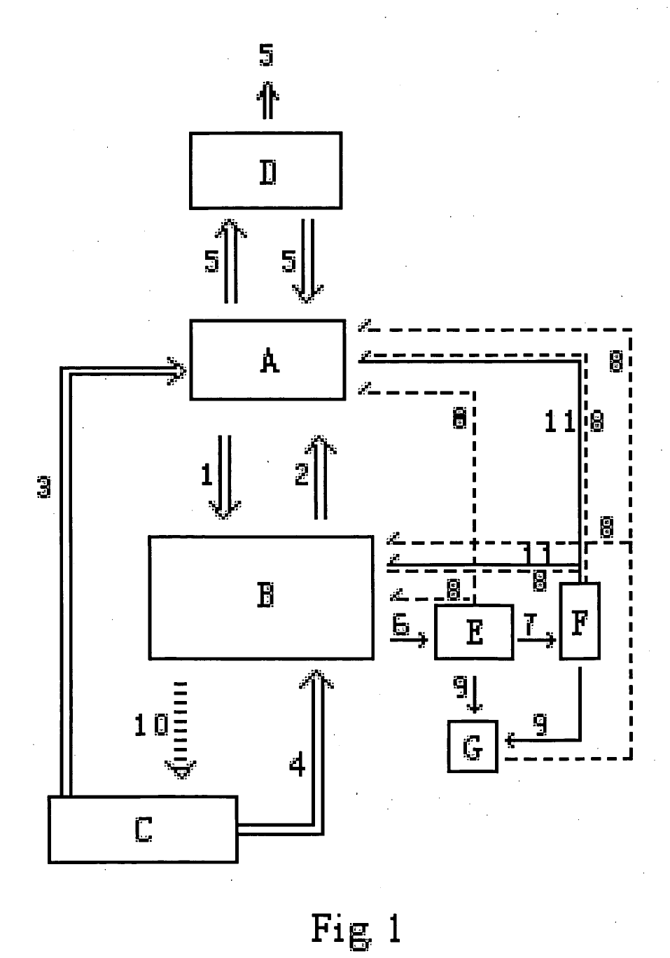

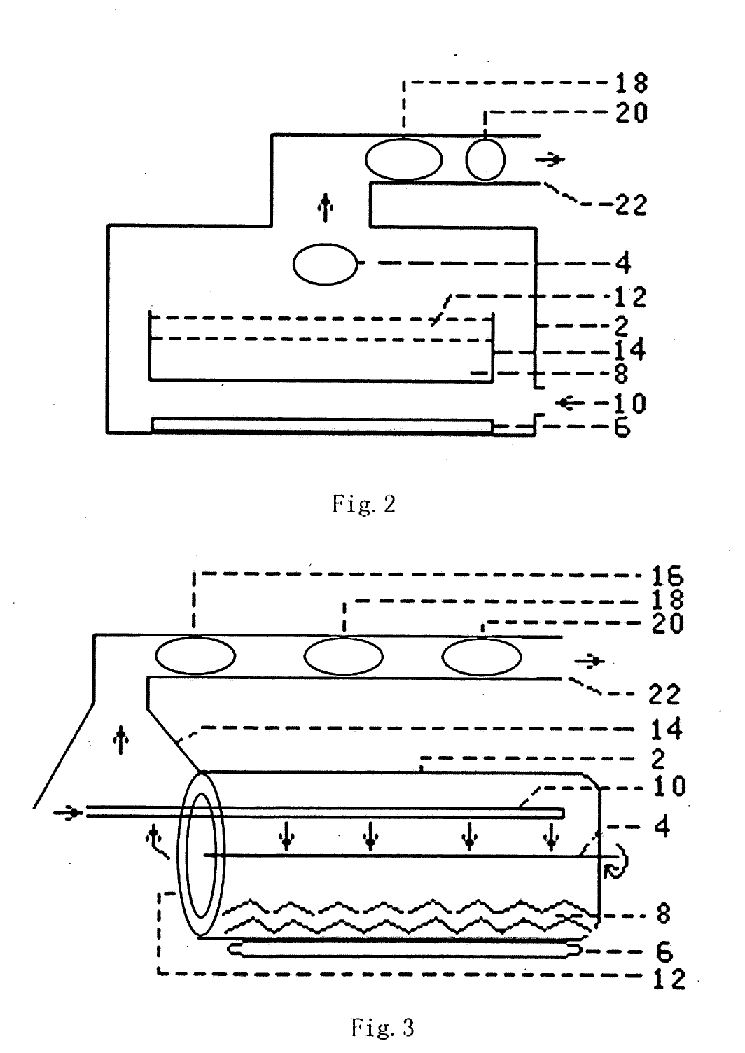

### EXAMPLES

### Example 1

### Preparation of Plant-Sourced SFCs, Preparation of SFC-VIII, and Compression Treatment of Plant-Sourced SFCs

Plant biomass as the raw materials for SFCs includes plant leaves, bars, stems, shells, skins, roots, flowers, seeds, beans, grasses, pulp, wood, barks, shrub, bamboo, sugar cane, sweet sorghum, sugar beet, rice, wheat, corn, rye, barley, oat, millet, hemp, flax, ramie, peanut, oil palm, tobacco, tea, cotton, cloth, paper, cartons, paper pulp, urban organic waste, garden waste, mushroom culture, seaweeds, sponge, algae, fungi, peat moss, above plant biomass that are chemically contaminated, above plant biomass that are fermented, or mixtures of the above.

Animal biomass as the raw materials for SFCs includes one or mixture of protozoa, coelenterate, annelid, mollusc, arthropod, fishes, amphibia, reptiles, birds, mammals, above animal biomass that are chemically contaminated, also include one or mixture of the whole bodies, organs, tissues and cells.

(1) Preparation A of SFC-I. Plant raw materials were from one or mixture of the following: wood chip, grasses, leaves, cloth, paper, carton, fermented organic waste or chopped straws. Mixed raw materials with 0-95% volume of the stabilizer, containing 40-60% moisture, then tiled on a baking tray, covered with 2-3 cm layer thickness of silica sands or iron sands. The tray was placed in a convection oven at temperature of 180° C. Heated for 24 hours after the sands reach 180° C. Stopped heating, cooled to room temperature, separated sands and product, and obtained SFC-I. Some carbons were gasified during the thermo-chemical process, part of the gasified materials could be condensed and collected as a new energy or new resource, the rest of gases was expelled after the alkali cleaning treatment. The carbon retention rate and non-carbon retention rate from raw materials to SFC-I was 85-95% and over 75%, respectively.

(2) Preparation B of SFC-I. Plant raw materials were from one or mixture of the following: hemp, flax, ramie, bamboo, chopped garden waste, mushroom culture, peat moss or algae. Mixed raw materials with 0-95% volume of the stabilizer, containing 40-60% moisture, then tiled on a baking tray, covered with 2-4 cm layer thickness of silica sands or iron sands. The tray was placed in a convection oven, raised the temperature gradually until 350° C. Heated for 30 minutes. Stopped heating, cooled to room temperature, separated sands and product, and obtained SFC-I. Some carbons were gasified during the thermo-chemical process, part of the gasified materials could be condensed and collected as a new energy or new resource, the remaining gas was expelled after the alkali cleaning treatment. The carbon retention rate and non-carbon retention rate from raw materials to SFC-I was 85-95% and over 75%, respectively.

(3) Preparation of SFC-II. Plant raw materials were from one or mixture of the following: tobacco leaves, tea leaves, cotton, cloth, paper, cartons, paper pulp, urban organic waste, garden waste, mushroom culture, seaweeds, sponge, algae, fungi, peat moss, wood chip, grasses, tree leaves, bamboo leaves, fermented biomass or chopped crop stalks. Mixed raw materials with 0-95% volume of the stabilizer, containing 10-60% moisture, then tiled on a baking tray, covered with 2-4 cm layer thickness of silica sands or iron sands. The upper part of the tray was connected to a gas collector, while the lower part was the focus point of the concave mirror or concave mirror group. Solar energy was focused on the lower part by concave mirror or concave mirror group of diameter 140 cm, heated for 2 minutes to 5 hours. The angle of concave mirror or concave mirror group was adjustable to receive solar energy efficiently. The tray was moving back and forth horizontally to make heat evenly distributed. Stopped heating, cooled to room temperature, separated sands and product, and obtained SFC-II. Some carbons were gasified during the thermo-chemical process, part of the gasified materials could be condensed and collected as a new energy or new resource, the rest of gases was expelled after the alkali cleaning treatment. The carbon retention rate and non-carbon retention rate from raw materials to SFC-II was 85-95% and over 75%, respectively.

(4) Preparation A of SFC-III. Plant raw materials were from one or mixture of the following: pine branches, pine needles, grasses, tree leaves, barks, plant roots, seaweed, algae, blue-green algae, kelp, banana skin, peach skin, apple core, pumpkin slices, pumpkin seed shells, corn leaves, corn cob, fermented flour, fermented glutinous rice, pickles and fermented organic waste. Mixed raw materials with 0-95% volume of the stabilizer and 0-0.5 M microwave sorption medium such as sea water, containing 30-60% moisture, then tiled on a microwave-inactive tray, covered with 1-2 cm layer thickness of silica sands. The tray was placed in a microwave oven (2450 MHz, output power 650 W), heated for 5 min-5 h at certain intervals, or heated until no smoke was produced. Stopped heating, cooled to room temperature, separated sands and product, and obtained SFC-III. Some carbons were gasified during the thermo-chemical process, part of the gasified materials could be condensed and collected as a new energy or new resource, the rest of gases was expelled after the alkali cleaning treatment. The carbon retention rate and non-carbon retention rate from raw materials to SFC-III was 85-95% and over 75%, respectively.

(5) Preparation B of SFC-III. Plant raw materials were from one or mixture of the following: soybean flour, wheat flour, rice flour, corn flour, sunflower seed shells, bagasse, soybean remains, newspaper, fungi, peat moss or heavy metals contaminated plants. Mixed raw materials with 0-95% volume of the stabilizer and 0-0.5 M microwave sorption medium such as sea water, containing 10-40% moisture, then tiled on a microwave tray, covered with 1-2 cm layer thickness of silica sands. The tray was placed in a microwave oven (2450 MHz, output power 650 W), heated for 5 min- 1 h, or heated until no smoke was produced. Stopped heating, cooled to room temperature, separated sands and product, and obtained SFC-III. Some carbons were gasified during the thermo-chemical process, part of the gasified materials could be condensed and collected as a new energy or new resource, the rest of gases was expelled after the alkali cleaning treatment. The carbon retention rate and non-carbon retention rate from raw materials to SFC-III was 85-95% and over 75%, respectively.

The particle size, layer thickness and density of silica sands or iron sands in (1)-(5) are the combined function for the proper flow resistance. The proper layering of sands as resistance could avoid the external oxygen to reach the covered raw materials, in the meantime allow heat to get in, and allow the produced moisture and gases to escape. An internal environment of oxygen-free, thermal conducting and gas release for the treated raw materials is created.

The stabilizer in (1)-(5) was from one or mixture of the following: fruits of plants, petroleum by-products, proteins, fats, gels, surfactants, chelators, sugars and salts, such as corn flour, rice flour, soybean powder, konjac powder, paraffin, Vaseline, asphalt, plastics, eggs, milk, fats, vegetable oils, gelatin, CMC, washing powder, glucose, sucrose, EDTA-Na₂, copper sulfate, ferrous sulfate, calcium carbonate, calcium sulfate, calcium phosphate and phosphoric acid. A protective layer was formed on the surface of raw materials to promote the long-term stability of SFC-I, II and III. By adding different stabilizer, one may get different products of hydrophobicity or hydrophilicity. For example, the hydrophobic carbon products were produced when plant fruits at neutral pH, by-products of petroleum, proteins or fats were used as the stabilizers; the alkaline hydrophilic carbon products were produced when CMC, washing powder or calcium carbonate was used as the stabilizer; the acidic hydrophilic carbon products were produced when EDTA-Na₂, copper sulfate or ferrous sulfate was used as the stabilizer; the positive charged carbon products were produced when ferric chloride was used as the stabilizer.

The microwave sorption media in (4)-(5) were the materials that could transfer microwave electromagnetic energy efficiently to heat energy. They have higher electric conductivity and dielectric constant, such as ethanol, acids, alkalis, salts and sea water.

(6) Preparation of SFC-IV. Plant raw materials were from one or mixture of the following: wood chip, grasses, tree leaves, bagasse, sorghum stem, peanut shells, tobacco leaves, tea leaves, cotton, chopped straw, fermented organic waste, polluted plants. Mixed the raw materials with 1-20 g/L citric acid solution for 20 minutes, squeezed off the solution, and put into the convection heating roller at 110° C.-350° C., preferred at 150° C.-260° C. Air containing 400-500 mg/hr ozone was introduced into the convection heating roller. Heated the materials to dry and some smoke was observed, added some 1-20 g/L citric acid solution and heated again to dry and smoke was observed, added some water and heated again until the materials were light-brown. Poured out the materials from the roller, cooled to room temperature, and obtained SFC-IV. The whole thermo-chemical process took 30-90 minutes. Moisture, dust and gasified materials were produced during the thermo-chemical process, part of the gasified materials could be condensed and collected as a new energy or new resource, the rest of gases was expelled after the alkali cleaning treatment. The carbon retention rate and non-carbon retention rate from raw materials to SFC-IV was 90-99% and over 80%, respectively.

(7) Preparation of SFC-V. Plant raw materials were from one or mixture of the following: wood chip, grasses, tree leaves, peanut shells or chopped straw. Obtained SFC-IV following the oxidative thermo-chemical procedure of (6), then treated SFC-IV with the oxygen-free thermo-chemical procedure of (1) or (2), SFC-V was obtained at the end. The carbon retention rate and non-carbon retention rate from raw materials to SFC-V was 75-90% and over 50%, respectively.

(8) Preparation of SFC-VI. Plant raw materials were from one or mixture of the following: wood chip, shrubs, grasses, tree leaves, or chopped straw. Obtained SFC-IV following the oxidative thermo-chemical procedure of (6), then treated SFC-IV following the solar oxygen-free thermo-chemical procedure of (3), SFC-VI was obtained at the end. The carbon retention rate and non-carbon retention rate from raw materials to SFC-VI was 75-90% and over 50%, respectively.

(9) Preparation of SFC-VII. Plant raw materials were from one or mixture of the following: wood chip, grasses, tree leaves, or chopped straw. Obtained SFC-IV following the oxidative thermo-chemical procedure of (6), then treated SFC-IV following the microwave oxygen-free thermo-chemical procedure of (4) or (5), SFC-VII was obtained at the end. The carbon retention rate and non-carbon retention rate from raw materials to SFC-VII was 75-90% and over 50%, respectively.

(10) Basic characteristics of plant SFCs.

| | | | SFC-V, |
|---|---|---|---|
| | SFC-I, II and III | SFC-IV | VI and VII |
| Look and Smell | black, odorless | brown, light odor | black, odorless |
| Chewing Taste | no taste, tough | some taste, | no taste, cotton |
| | | soft tough | soft |
| Water Solubility | little, no color | some, color | little, no color |
| pH | 6.5-7.2 | 6.0-7.0 | 6.5-7.5 |
| Hydrophobicity | strong | stronger | stronger |
| Stability | strong | strong | stronger |
| Anti-Degradation | strong | stronger | strongest |
| Sorption | strong | stronger | strongest |

(11) Compression of plant-sourced SFCs. SFC-I, II, III, IV, V, VI or VII was packed by hydraulic pressure, 100-1500 tons/m². The storage space for compressed SFCs was saved by 30-70%. The transportation cost and storage cost for compressed SFCs were saved. The long-term stability of compressed SFCs was enhanced by 20%, while the fire-retardation and waterproofing characters were also enhanced. SFCs could be vacuum packed after hydraulic pressure. The long-term stability of vacuum compressed SFCs was enhanced by over 20%.

(12) Preparation A of SFC-VIII. Dead animal raw materials were from one or mixture of the following: ants, insects, earthworms, eggs, birds, mice, fishes, frogs or snails. Applied air dry, sun dry, bake dry, microwave, toast dry or concave mirror to the raw materials for pre-dehydration until 10-20% moisture content was reached. Stored the pre-dehydrated materials in a dry pyramid warehouse for continuous dehydration, a moisture content below 8% could be reached at the end. The pyramid warehouse was a four-corner coned building, connected by bamboo nails, no metal components, 80 cm long at the bottom, 54 cm high, 51 degrees tilted to the center on each side. The upper half of the pyramid was made of wood or SFCs composite, outer surface was painted in dark. The lower half of the pyramid was made of the transparent plastic film with the greenhouse effect. The pyramid was placed on a platform, oriented in north-south direction. No water was accumulated on the platform. There was a 1-2 cm gap between the pyramid bottom and the ground, the gap was screened to prevent insects from entering. There were air holes with a rain cover on top of the pyramid, in favor of the air exchange. The carbon retention rates from raw materials to SFC-VIII were varied from different pre-dehydration treatments. The carbon retention rates from treatment of air dry, sun dry or bake dry were 95-99%, while from that of concave mirror, microwave or toast dry were more than 75%.

(13) Preparation B of SFC-VIII. Plant raw materials were from one or mixture of the following: soybeans or peanuts. Applied air dry, sun dry, bake dry, microwave, toast dry or concave mirror in summer to the raw materials for pre-dehydration until moisture content below 20% was reached. Stored the pre-dehydrated materials in a dry pyramid warehouse for continuous dehydration. The pyramid was designed as (12). The carbon retention rate and non-carbon retention rate from raw materials to SFC-VIII was 75-99% and over 75%, respectively.

(14) Preparation C of SFC-VIII. Dead animal raw materials were from one or mixture of the following: fish or pork, cut into strips or sheet. Applied air dry, sun dry, bake dry, microwave, toast dry or concave mirror in summer to the raw materials for pre-dehydration until moisture content below 20% was reached. Buried the pre-dehydrated materials in sodium carbonate or lime powder, salt drying for 2-15 days for continuous dehydration. Then stored in a dry pyramid warehouse for continuous dehydration, moisture content below 8% could be reached at the end. The pyramid was designed as (12). The carbon retention rate and non-carbon retention rate from raw materials to SFC-VIII was 75-99% and over 75%, respectively.

### Example 2

### Indoor Storage of Plant SFCs under Natural Conditions

Bagged and stack piled, 50 tons of wood SFCs, grass SFCs, tree leave SFCs and straw SFCs had been stored indoors without ventilation under natural conditions for six years. There were no broken or degradation signs, no mildew, no signs of disease, no signs of fermented heat, no release of toxic gas or smell. Some SFCs near the window and under direct sun showed no difference, neither. Workers who had worked in the environment for six years felt no discomfort.

Plant SFCs were plastic packed by hydraulic pressure, volume was reduced by 50%. They were stored indoors and in dark for 1 year, showing no abnormalities.

Plant SFCs were vacuum sealed after hydraulic pressure, volume reduced by 60%. They were stored indoors and in dark for 1 year, showing no abnormalities.

### Example 3

### Outdoor Storage of Plant SFCs under Natural Conditions

Wood SFCs in a mesh bag had been placed on a platform outdoors without shelter for four years, under sun and rain, summer and winter. Although the mesh bag had been degraded completely, the packing volume of SFCs maintained almost the same, there was some damp moldy smell. While the untreated wood chip in the control group showed 50-60% shrink of the packing volume, became stinking rot.

### Example 4

### Outdoor Storage of Plant SFCs in Dirty Water

Wood SFCs had been submerged in a no-flowing water pool outdoors without shelter for two years; the water was black and stinks. Although the SFCs became black and stinks, the packing volume of SFCs maintained almost the same. While the untreated wood chip in the control group became degraded slag and stinking rot.

### Example 5

### Storage of Plant SFCs in Dark Damp Soil, or in Sealed Barrel

(1) Wood SFCs and straw SFCs were buried in the dark damp soil, 15 cm deep, covered with 15 cm thickness soil. They were dug up 18 months later. The original shapes of SFCs were maintained. While the untreated straw in the control group was decayed evidently.

(2) 20 L of straw SFCs was mixed with 500 ml yogurt and 2 L water, put into a sealed barrel and buried in a haystack indoors. It was dug out after two years, the SFCs remained moist and maintained the original shape. No mildew, no signs of disease, and no odor were observed.

### Example 6

### Aquaculture in Plant SFCs-Soaked Water

500 grams of wood SFCs and 500 grams of straw SFCs were immersed in 20 liters of water for 5 days. Took out the SFCs. Fish were raised in the soaked water, and air oxygenating was supplied. Fish were farmed for one month, healthy and lively.

### Example 7

### Planting on Plant SFCs Mixed Soil

Dug a hole in the garden, 20 cm thickness of SFCs were buried, and covered with 10 cm thickness of soil. Planted grass, flowers and trees on the soil, all grew in good condition, similar to the control group.

### Example 8

### Plant SFCs were used in the Vegetable Field

(1) Grew green leafy vegetables in a vegetable field of normal soil quality. Watered the vegetables only with the straw SFCs-soaked water in the whole process from germination, emergence, growth to harvest. Vegetables grew well, no pests and, diseases were observed. Vegetables had a better taste. Birds appeared to love to feed on them too.

(2) Grew green leafy vegetables in a vegetable field of normal soil quality. Watered the vegetables only with the straw SFCs-soaked water, and fertilized the vegetables only with the organic manure obtained from SFCs-anaerobic treatment of polluted water. Vegetables grew well, no pests and diseases were observed. Vegetables had a better taste. Birds appeared to love to feed on them too.

(3) Grew green leafy vegetables in a vegetable field mixed with straw SFCs. A vegetable plot was divided into 6 groups, each covered with 20 cm thickness of mixtures of straw SFCs and topsoil. The mixtures had the following volume ratio of straw SFCs and topsoil, 0, 2, 4, 8, 12 and 50 to 100, respectively. The sprouting and the growth of the group of 4:100 and group of 8:100 were superior to other groups, no pests and diseases were observed. Vegetables had a better taste. Birds appeared to love to feed on them too. Residues of straw SFCs could be seen two years later.

(4) Grew green leafy vegetables in a vegetable field mixed with straw SFCs, a pyramid greenhouse was on the field. Watered the vegetables only with the straw SFCs-soaked water, and fertilized the vegetables only with the organic manure obtained from SFCs-anaerobic treatment of polluted water. Vegetables grew very well, no pests and diseases were observed. Vegetables had a better taste. Birds appeared to love to feed on them too.

### Example 9

### Plant SFCs Feed Chickens as Feed Additives

Two groups of two-month old chickens, three in each group, were fed separately, drinking from the same water source. The control group was fed with normal diet, while the experimental group fed with a mixture of 1:3 volume ratio of straw SFCs and normal diet. The survival, appetite, growth rate, feather brightness, and the level of health of the experimental group were better than that of the control group. The color of chicken manure of the experimental group was deeper than that of the control group, while the odor of the manure of the experimental group was weaker than that of the control group. Remanence of SFCs in the manure was visible in the experimental group. The experimental group drank less water than the control group. The brightness and length of cockscomb in the experimental group were evidently better than that of the control group. Three months later, the chickens were killed and anatomized. The weight of the experimental group was evidently higher than that of the control group. Both groups had healthy and normal organs. The taste of chicken meat of the experimental group was slightly better than that of the control group. After anaerobic treatment, manure from the experimental group could turn into new energy sources and organic fertilizer. Manure from the experimental group could also turn into organic fertilizer after earthworm digestion.

### Example 10

### Plant SFCs Feed Fish as Feed Additives

Two groups of fish were fed separately in a slightly diesel polluted pool, and air oxygenating was supplied. The control group was fed with normal diet, while the experimental group fed with a mixture of 1:3 volume ratio of straw SFCs and normal diet. One month later, the survival, appetite, growth rate, and the level of health of the experimental group were better than the control group. The color of fish manure of the experimental group was deeper than that of the control group. Residue of SFCs in the manure was visible in the experimental group. The diesel smell of fish meat from the experimental group was evidently lower than that of the control group. After anaerobic treatment, manure from the experimental group could turn into new energy sources and organic fertilizer.

### Example 11

### Plant SFCs Feed Pigs as Feed Additives

One-month old pigs were fed with a mixture of 1:3 volume ratio of straw SFCs and normal diet. Pigs appeared to love the fodder, and grew well.

### Example 12

### Plant SFCs as the Capture Material and Sterilization Material for CO₂, CO, N₂O, SO₂, H₂S, CH₄, Formaldehyde, Ammonia and p-xylene

(1) 5 L of wood SFCs were mixed with of sodium carboxymethyl cellulose (CMC) 50 g, 5% benzalkonium bromide 200 ml and sodium silicate (Na₂SiO₃) 100-200 g (or sodium hydroxide, calcium oxide, calcium hydroxide, calcium carbonate, sodium carbonate, sodium bicarbonate), then put into an air cleaner as the sorption medium. The cleaner was able to clean the acidic air pollutants, such as CO₂, CO, N₂O, SO₂ and H₂S, when high moisture was maintained in the sorption medium, until pH value of the sorption medium became neutral. The produced, carbonate, nitrate, nitrite, sulfate or sulfite after the chemical reaction was sorbed and stored in the porous structure of SFCs. pH of used SFCs became neutral or slightly acidic. The used SFCs could be land filled, or utilized as the building material, fertilizers, soil reformers or saline-alkali land reformers.

(2) 5 L of wood SFCs were mixed with of 50 g of CMC, 200 ml of 5% benzalkonium bromide and 100-200 g of ammonia or organic amines, then put into an air cleaner as the sorption medium. The cleaner was able to clean formaldehyde, p-xylene, CO₂, CO, N₂O, SO₂ and H₂S, when high moisture content was maintained in the sorption medium.

(3) 5 L of wood SFCs were mixed with a solution of 250 g EDTA-Na₂, pH 9-11, then put into an air cleaner as the sorption medium. The cleaner was able to clean formaldehyde, ammonia, p-xylene, CO₂, CO, N₂O, SO₂ and H₂S, when high moisture content was maintained in the sorption medium.

(4) 5 L of wood SFC-IV was put into an air cleaner as the sorption medium, sprayed the sorption medium with 0.1 M sodium hydroxide continuously. The cleaner was able to clean the acidic air pollutants, such as CO₂, CO, N₂O, SO₂ and H₂S, until pH value of the spray solution became neutral.

(5) 5 L of CMC-treated wood SFC-IV was put into an air cleaner as the sorption medium. The cleaner was able to clean formaldehyde, ammonia, p-xylene, CO₂, CO, N₂O, SO₂ and H₂S, when high moisture content was maintained in the sorption medium.

(6) 5 L of microporous and dense wood SFC-IV was mixed with a solution of 250 g EDTA-Na₂, pH 5, and 500 g of zinc oxide, then put into an air cleaner as the sorption medium. The cleaner was able to clean the low concentration of CH₄ gas, when high moisture content was maintained in the sorption medium.

(7) Microporous and dense plant SFCs can be obtained from dry or wet plant SFCs under hydraulic pressure of 500-3000 tons/m². The ratio of micropores to the total pores in the compressed SFCs was evidently increased, while 40-80% of the storage volume was saved. The higher was the hydraulic pressure, the higher was the ratio. The ratio was higher from treatment of wet SFCs than from dry SFCs. One can get the microporous and dense plant SFCs from the dense raw materials, such as pine needles and tree leaves with surface protective layer. Microporous and dense plant SFCs, together with the modified chemical groups or metal sorption sites on its structure, were able to capture and store the small molecules at lower pressure, such as CO₂, natural gas or hydrogen gas. The stored CH₄ gas or hydrogen gas was relatively stable, and could be released when necessary. After treatment of (1), (3), (5) or (6), the microporous and dense plant SFCs had even better capability to catch the pollutants.

(8) 60 L of wood SFC-IV was mixed with 0.01-0.2% potassium permanganate and 1-10 g/L sodium bicarbonate, then put into an air cleaner as the sorption medium. Rinsed the sorption medium with 0.01-0.2% potassium permanganate and 1-10 g/L sodium bicarbonate continuously, and kept the cleaner working in dark. The cleaner was able to kill bacteria and to clean formaldehyde, ethylene, VOCs, N₂O, SO₂ and H₂S.

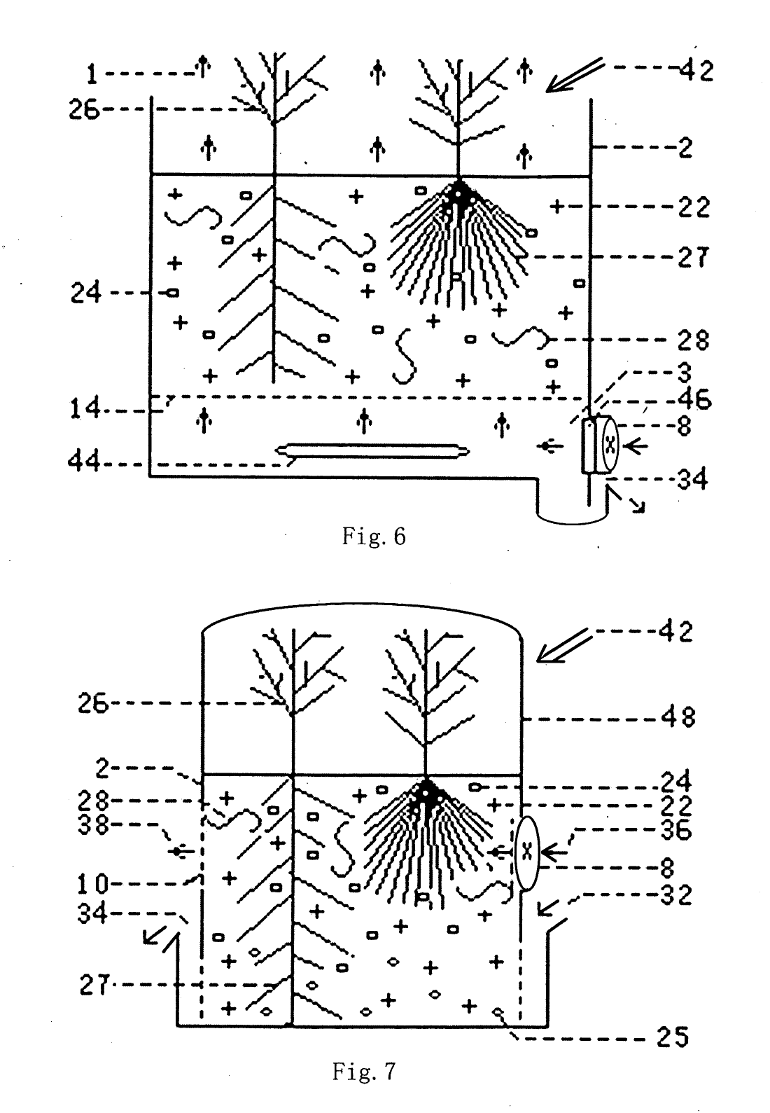

(9) Sample of the indigenous microorganisms (including methane-degrading bacteria) from the methane emission-intensive landfill site, was introduced into a mixture of 30 L wood SFC-IV and 30 L straw SFC-IV, then put into an air bioreactor (see FIG. 6) as the sorption medium. Plants with well-developed root system were transplanted on the medium. Methane gas was introduced for the bacteria domestication in the bioreactor for long time. Methane was cleaned with 20-40% efficiency. If the more efficient strains of methane bacteria are introduced, the methane cleaning is expected to be greatly improved.

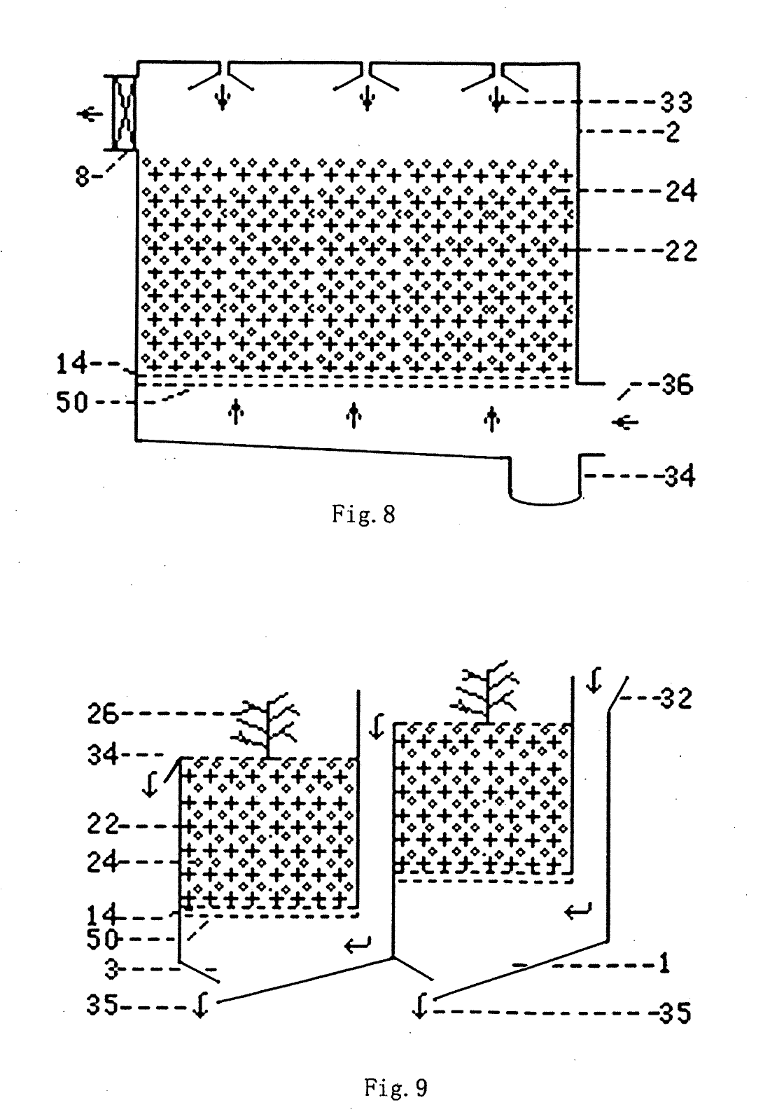

(10) 60 L of wood SFC-IV was mixed with 0.2-0.8 mg/L CuCl₂ and 0.02-0.08 mg/L AgCl₂, then put into an air cleaner (see FIG. 8) as the sorption medium. Rinsed the sorption medium with 0.2-0.8 mg/L CuCl₂ and 0.02-0.08 mg/L AgCl₂ continuously, and supplied the polluted air from central air-conditioning. The cleaner was able to kill Legionella bacteria and some pathogenic microorganisms in the polluted air.

### Example 13

### Plant SFCs-Mediated Enzymatic Reduction of Carbon Dioxide

There are plenty of the soluble protein, carbonic anhydrase isoenzymes (EC 4.2.1.1), in ferns, algae and chloroplasts of angiosperms. Highly catalytic activity of carbonic anhydrase isoenzymes have been found in the spinach leaves, pea leaves and algae. An availability on a large scale and economical supply of carbonic anhydrase activity could be obtained directly from the cell lysate of plant leaves or algae, without further separation and purification. The mixture of SFCs and the cell lysate in a CO₂ scrubbing apparatus, thus, could change the gaseous CO₂ into the liquid bicarbonate by physical sorption, chemical sorption and biological enzyme catalysis, and further change the liquid bicarbonate into the solid carbonate by precipitation.

Methods: Harvested spinach from a vegetable field of adequate sun and zinc supply, and kept the leaves. Freeze-thawed the fresh spinach leaves for 2-4 cycles to break the cell walls, carbonic anhydrase was released. The reduction protective agents of 10 mM cysteine and 10 mM phosphate buffer (pH 7.5) were added in the cell wall breaking course. After a 60 μm nylon mesh filter, the spinach lysate which contains stable carbonic anhydrase activity was obtained. SFCs were mixed with the spinach lysate, and loaded in the CO₂ scrubbing apparatus as shown in FIG. 11. CO₂ gas was applied to the apparatus while a spray solution was supplied. Spray solution was a mixture of spinach lysate and diluted lime water, pH 7-9. The washed-off bicarbonate, then, was reacted with lime water or sea water to generate solid carbonate precipitate. In a 2.25 m³ pilot cabin, there was high concentration of CO₂ released from bio-fuel combustion, indication candles were extinguished due to oxygen absence. The apparatus in the cabin allowed the CO₂ concentration to decrease more than 60% in 10 minutes, and allowed the CO₂ concentration to decrease more than 80% in 20 minutes.

The donor of carbonic anhydrase can also be from blue-green algae, ferns, pea leaves, parsley leaves, dwarf beans leaves, sunflower leaves, lettuce leaves or barley leaves. Ultrasonic oscillation or sand milling method can be used in the cell lysis process. Plant carbonic anhydrase isoenzymes lose the activity easily in the oxidizing environment or the environment with some anions such as NO₃⁻, Cl⁻, SO₄²⁺. The activities of isoenzymes in the lysate was protected by adding the sulfhydryl group-containing reduction protective reagents, such as 10 mM cysteine or 100 mM 2-mercaptoethanol or 1 mM DTT, as well as the alkaline pretreatment of the polluting gases to remove the interference anions. In order to maintain a high activity of plant carbonic anhydrase in the apparatus, the concentration of fresh carbonic anhydrase of the spray solution was adjusted. Solid carbonate precipitation could be formed from the bicarbonate ion by adding Ca²⁺ or Mg²⁺ or Fe²⁺.

### Example 13

### Composites of Plant SFCs and Cement

Light building materials can be made of the following three components: the organic component from the fibrous, granular or powdered SFCs; the inorganic fillers such as fly ash, coal gangue, slag, stone, ores, rock wool, mineral wool, glass wool or silicate; and the adhesives such as Portland cement or plaster composite materials.

SFCs composite was made from wood SFCs, straw SFCs, fly ash, cement, bentonite, or gypsum, via mechanical mixing, press molded and air dried in the shade. Formulations of the composite were flexible. One example for the composite: mixing volume ratio of SFCs, cement or gypsum, fly ash was 3:3:10.

Dropping water on the surface of the composite, one could see water droplets drew themselves in isolated spheres, slowly sorbed, while droplets on the conventional building materials in the same circumstances were rapidly infiltrating. Immersed the composite in water for several weeks, no phenomenon of breakdown was observed; the mechanical strength was slightly changed; the size was slightly increased. The composite contained a large number of porous organic structures which were filled with air. The dense, complex and hydrophobic porous structure of the composite could effectively prevent the thermal convection of air and control moisture flow in and out of the building. The composite was functioning as an ecological isolation layer. It was not combustible in high-temperature flame for one hour, only some became ashes, no toxic gases produced. The fire-retardant feature of the composite was superior to that of the conventional organic synthetic insulation materials. The composite could be nailed, cut, sawed, pressured, anti-pull, anti-warping deformation and anti-crack. There were less dust and fiber produced in the use and at the time of demolition of the composite. The mechanical and secure features of the composite were superior to that of the conventional inorganic insulation materials. The composite was light weighted, which was ½-⅕ of the weight of solid clay brick. The composite might be attacked by mildew if exposed to damp environment for long time. Borax, boric acid or other preservatives was effective in preventing mold growth in the composite. Depending on the different formula and SFCs ratio, the composites had the R-value range of R-1.5 to R-2.5 per inch. The composite contained a large number of porous structures, and a high ratio of the open and interconnected pores. It had good sound sorption effect, especially in the efficacy of middle and high-frequency sound sorption. The sound sorption of the composite was slightly weaker than that of the compacted cotton, but stronger than that of pure organic insulation materials. The composite was crushed two years later, the fibers and strength of fibers were well preserved.

### Example 15

### Glued Plant SFCs Composites

By adding appropriate glue into plant SFCs, a variety of composite plates and blocks can be compressed. A certain percentage of organic carbon materials such as plastics (e.g., polypropylene), rubbers, resins (e.g., epoxy resins), paraffin, Vaseline, bitumen, tar, etc., can be added in the composite. Or a certain percentage of inorganic fillers such as pulverized fly ash, coal gangue, slag, rock wool, glass wool, rock powder and mineral sands can be added in the composite. R value range of the composite was about R-1.8 to R-3.0 per inch. The sound sorption of the composite was slightly weaker than that of the compacted cotton, but stronger than that of the pure organic insulation materials. The composite was crushed two years later, the fibers and strength of fibers were well preserved.

### Example 16

### Plant SFCs Composites with Organic Hydrophobic Bonder

SFCs can be the main organic component to prepare light-weight building materials. The other components in the composite include the hydrophobic polymer materials such as plastics (e.g., polypropylene), rubbers, resins, paraffin, Vaseline, bitumen or tar; and the inorganic fillers such as fly ash, coal gangue, slag, rock powder, mineral sands or industrial solid waste mixture.

(1) The melted thermoplastics such as polyethylene (PE) or polyvinyl chloride (PVC) or polypropylene (PP) was mixed well with wood SFCs or straw SFCs at the volume ratio of 10:1 to 1:5. After press molded and cooled, the organic polymeric composite was obtained. 1-99% of SFCs could be replaced by rubber powder or thermosetting plastic powder. Or 1-50% of SFCs could be replaced by the inorganic fillers, such as fly ash, coal gangue, slag, rock wool, glass wool, rock powder or mineral sands. The composite was of higher strength, hardness and toughness. R value range was about R-2.0 to R-3.0 per inch. The sound sorption of the composite was slightly weaker than that of the compacted cotton, but stronger than that of pure organic insulation materials. The composite was immersed in water for several weeks; there was no change to the mechanic strength.

(2) One or mixture of the melted hydrophobic thermoplastics, resins, polypropylene, paraffin, Vaseline, bitumen or tar was mixed well with wood SFCs or straw SFCs at the volume ratio of 10:1 to 1:5. After press molded and cooled, the organic polymeric composite was obtained. 1-99% of SFCs could be replaced by rubber powder or thermosetting plastic powder. Or 1-50% of SFCs could be replaced by the inorganic fillers, such as fly ash, coal gangue, slag, rock wool, glass wool, rock powder or mineral sands. The composite was of higher strength, hardness and toughness. R value range was about R-2.0 to R-3.6 per inch. The sound sorption of the composite was the same as that of the compacted cotton, and was stronger than that of pure organic insulation materials. The composite was immersed in water for several weeks; there was no change to the mechanic strength.

### Example 17

### Utilization of Plant SFCs in the Agricultural Pollution Control

(1) Took 5 kg dry garden soil, added 500 ml 20 μg Pb²⁺/ml lead acetate, mixed, and divided into two groups. 500 g of straw SFCs was added and mixed in the experimental group. Planted the green leafy vegetables on the lead contaminated garden soil. The budding rate and growth in the experimental group was better than that of the control group. Two months later, the soluble lead ion concentration of soil was tested. The lead concentration of the experimental group was 30% of that in the control group.

(2) Took 5 kg dry garden soil, added 500 ml 20 μg Hg²⁺/ml mercury nitrate, mixed, and divided into two groups. 500 g of straw SFCs was added and mixed in the experimental group. Planted the green leafy vegetables on the mercury contaminated garden soil. The budding rate and growth in the experimental group was better than that of the control group. Two months later, the soluble mercury ion concentration of soil was tested. The mercury concentration of the experimental group was 30% of that in the control group.

(3) Took 5 kg dry garden soil, added 500 ml of 0.002% organic phosphorus pesticide Triazophos, mixed, and divided into two groups. 500 g of straw SFCs was added and mixed in the experimental group. Planted the green leafy vegetables on the pesticide contaminated garden soil. The budding rate and growth in both groups were the same. Two months later, the soluble pesticide concentration of soil was tested. The pesticide concentration of the experimental group was 30-40% of that in the control group.

(4) Prepared 0.002-0.04% Triazophos and 0.002-0.04% the organic phosphorus pesticide Acephate, respectively. The samples were applied on the hydrophobic wood SFCs for 1 hour and 20 hours of sorption test. The result showed that the sorption efficiency of 20 hours was higher than that of 1 hour, and the sorption efficiency for Triazophos was evidently higher than that of Acephate. The result is consistent with the literature data, where Triazophos is dissolved at 39 mg/L, and Acephate is at 790 mg/L in 20° C. water. Therefore, it is reasonable to assume that the hydrophobic SFCs may have better sorption for the highly hydrophobic pesticides than for the hydrophilic pesticides.

### Example 18

### Utilization of Plant SFCs in Oil-Water Separation, Oil Spill Cleaning, and Laboratories' Sewage Cleaning

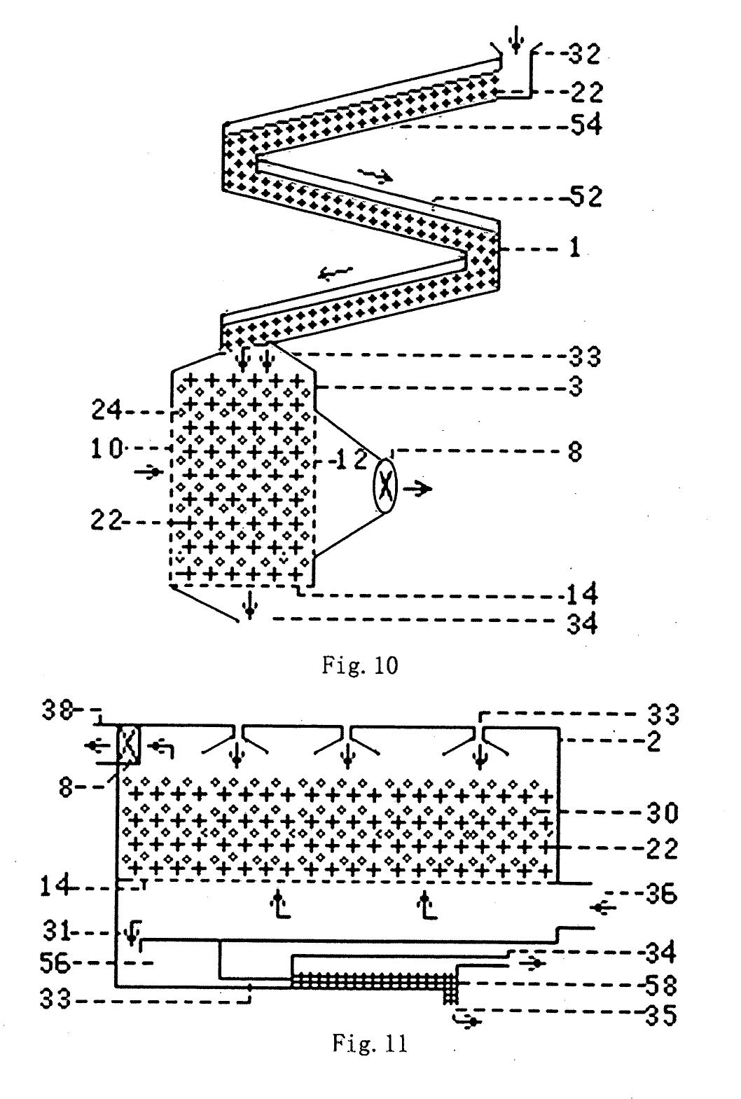

(1) Treatment of kitchen oily sewage: Applied 50 liters of highly concentrated kitchen oily sewage to the filtration/sorption compartment 1 of sewage cleaner (see FIG. 10). No trace of oil was shown on the surface of outlet water.

(2) Treatment of laboratories' sewage: Prepared a mixture of highly concentrated laboratories' sewage including benzene, xylene, nitrobenzene, ethyl acetate, chloroform, ethyl ether, petroleum ether, phenol, aniline, acetone, rosin water, paint, gasoline, kerosene and waste lubiicating oil. Shook vigorously the mixture into an emulsion-like solution, and applied it to the filtration/sorption compartment 1 of sewage cleaner (see FIG. 10), the outlet water was clear, showed no organic phase, and smelled only slightly.

(3) The plant SFCs were processed by the conventional expanding technique, resulting in a substantial increase in porosity, and its sorption capacity of organic molecules was further enhanced. Applied the expanded SFCs as the sorption media, repeated the treatment of laboratories' sewage in (2), the cleaning efficiency was enhanced.

(4) Oil spill cleaning: Poured 2 liters of waste oil on water. The oil spill was surrounded by SFCs-filled booms, and covered by SFCs-filled mesh bags. A few minutes later, took out the sorption bag, almost no traces of oil were shown on the surface of the water.

(5) Fried food and oily food-handling: Oil-sorbing pads were made of plant SFCs. Placed an oil-sorbing pad on a plate, and put the deep-fried food or oily food on it. All liquid oil in the food was transferred to the oil-sorbing pads in a few minutes.

(6) Added adequate microbes to the oil-SFCs complex, and put into the SFCs aerobic water bioreactor. Keeping the supply of water and nutrients, oil pollution was decomposed after certain time.

(7) The collected oil-SFCs complex can be used to prepare bio-diesel.

### Example 19

### Physical Sorption and Chemical Sorption of Plant SFCs for Kitchen Fume

An fume sorption cleaner was made of the front compartment of wet hydrophobic SFCs, and the back compartment of wet hydrophilic SFCs treated with calcium carbonate and surfactants. Oily smoke and pungent odors of kitchen fume were produced by adding chili peppers into hot oil. The inlet fume concentration was 42.8 mg/m³, while the outlet fume concentration was 5.3 mg/m³, the cleaning rate was 87.5%. The cleaning for VOCs and unpleasant odors was also evident.

### Example 20

### Physical Sorption and Chemical Sorption of Plant SFCs for Polluted Gases

CMC-treated wood SFC-V was filled into a gas mask as sorbent, and kept the sorbent moist. Sulfur dioxide generated by burning coal could be cleaned by the mask.

A mixture of wood SFC-IV and straw SFC-IV of 1:1 volume ratio was put into a SFC physical sorption cleaner, kept the sorbent moist. The cleaner had a cleaning rate of 60% for 1 mg/m³ formaldehyde, and a rate of 80% for 10 mg/m³ ammonia, and a rate of 70% for the rancid gases. However, the cleaning ability was declined very rapidly with repeated uses.

A chemical sorption air cleaner was made of the front compartment and the back compartment. The front compartment was filled with the wet sorbent of 10 L of wood SFCs, 20 g of CMC, and 250 g of EDTA-Na₂, pH 10. The back compartment was filled with the wet sorbent of 10 L of wood SFCs, 20 g of CMC, and 250 g of EDTA, pH 3. Kept the sorbents moist. Cleaning ability was maintained for a long time.

(1) Cleaning of polluted gases with single component. Experiment 1: Applied the above chemical sorption air cleaner for one cycle cleaning (one-time cleaning process), 0.8 mg/m³ formaldehyde became 0.08 mg/m³ after cleaning; and 8.7 mg/m³ ammonia became 0.1 mg/m³ after cleaning. Experiment 2: In a 2.25 m³ pilot cabin, the above chemical sorption air cleaner was run for 5 minutes, 0.98 mg/m³ formaldehyde was down to 0.26 mg/m³; and 1.1 mg/m³ ammonia was down to 0.3 mg/m³.

(2) Cleaning of polluted gases with complex components. Experiment 1: In the 2.25 m³ pilot cabin, various odor sources were introduced to release formaldehyde, ammonia, toluene, chloroform, benzoic acid, gasoline, paint, rotten eggs, rotten fish and rotten tofu, so the cabin was full of the strong mixed odors. The above chemical sorption air cleaner was run for 10 minutes, the odor became much weaker. Experiment 2: In the 2.25 m³ pilot cabin, 20 low-quality cigarettes were lit at the same time, so the cabin was full of the thick smoke and choking odor. The above chemical sorption air cleaner was run for 15 minutes, the smoke was disappeared completely; run for another 5 minutes, the odor became much weaker. Experiment 3: Automobile exhaust cleaning. CMC-treated wood SFC-IV was put into a SFC chemical sorption cleaner, and kept the sorbent moist. Placed the cleaner at a site of high concentration of vehicle exhaust near a traffic tunnel exit. The cleaning effect was evident, and the outlet had no choking odor.

### Example 21

### Cleaning by Plant SFCs for Sewage Containing Biodegradable Pollutants

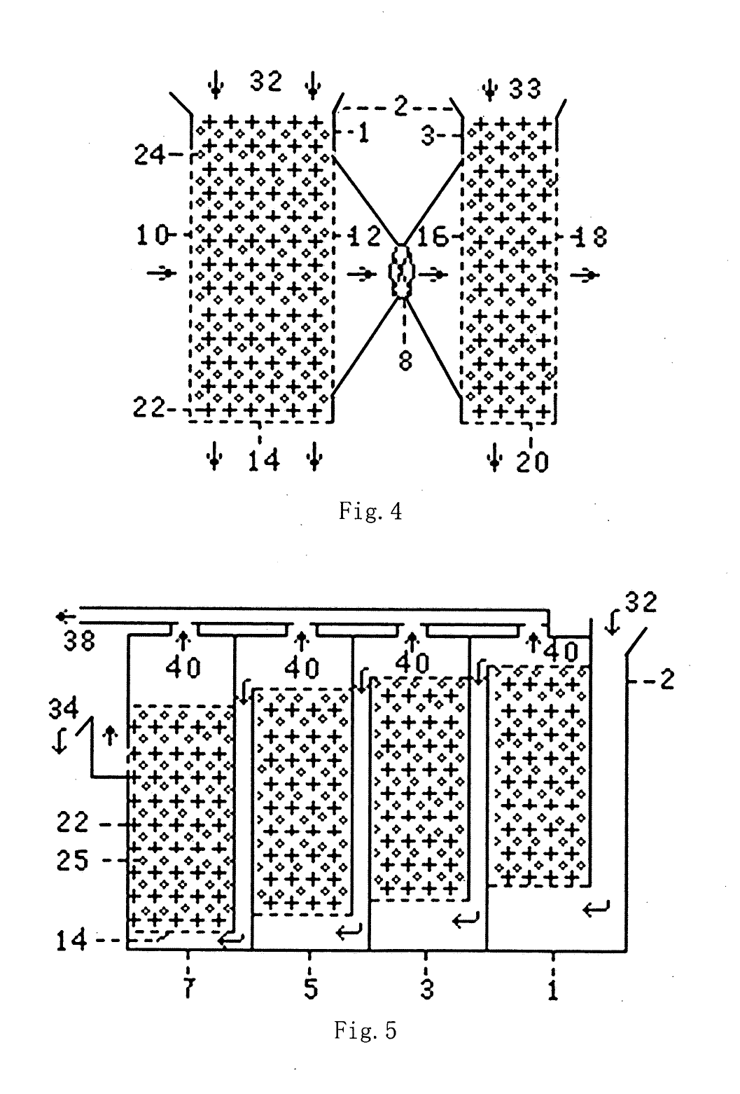

For cleaning of various biodegradable pollutants in industrial wastewater, agricultural wastewater and domestic sewage, SFCs aerobic cleaning method could be used. In a SFCs aerobic sewage bioreactor (see sewage cleaning compartment 1 of FIG. 4), the oxygen concentration in the gas-liquid-solid three-phase was greatly enhanced by the SFCs medium. The oxygen concentration may be ten times higher than the dissolved oxygen saturation concentration in clear water at the standard state (0.1 Mpa, 20° C.). Thus, the bioreactor provided the indigenous aerobic microbial communities on SFCs with adequate oxygen supply and suitable eco-living environment, and further enhanced the capability of the microbes to digest the pollutants accumulated on SFCs. Small amount of fungi, protozoa and micro-metazoan that grew naturally in the SFCs environment, also participated in the decomposition of pollutants. The air cleaning part (see air cleaning compartment 1 of FIG. 4) would enable the odor from sewage to be cleaned. During the pollution decomposition process, SFCs as the oxygen carrier, pollutant carrier and microbe carrier, were quite stable themselves and maintained carbon negative.

(1) Sewage often have a large number of solid particles, such as blue-green algae. An upward sewage bioreactor (see FIG. 9) could be applied to achieve the efficient removal of suspended particles for pre-treatment of sewage.

(2) Blue-green algae or microalgae can be cultured in the eutrophic water bodies at adequate light and temperature of 25-35° C. The gas-liquid exchange system on SFCs (see sewage cleaning compartment 1 of FIG. 4) could provide algae the dissolved CO₂ from CO₂ polluted air. In addition, an upward sewage bioreactor (see FIG. 9) could be applied to achieve the efficient separation of the matured algae and water. As a result, the eutrophic water bodies were cleaned; nitrogen and phosphorus were removed; atmospheric CO₂ was fixed; biomass as algae was produced for further utilization, such as for the raw material of SFCs, donor of carbonic anhydrase, biofuel, biogas and organic fertilizer.

(3) A stinky sewage mixture from the chemical industry, paint, laundry, rotten vegetables and fecal matter, was applied to the SFCs aerobic sewage bioreactor. The outlet water was clear and odorless. The bioreactor remained high cleaning efficiency, even at 1-2° C. in winter.

(4) Raised for a month in the outlet water from (3), kept the air oxygenating, the fish were in good condition, healthy and lively.

(5) The green leafy vegetables in a vegetable field of normal soil quality, were watered with the outlet water from (3). Vegetables grew well in the whole process from germination, emergence, growth to harvest, no pests were observed. Birds appeared to love to feed on them.

(6) The wood SFCs from one-year running of the SFCs aerobic sewage bioreactor, showed no signs of evident degradation.

### Example 22

### Plant SFCs for Sewage Containing Pollutants, Toxins, Particles and Eutrophic Substances that are hard to be Biodegradable

Various industrial wastewater, agricultural wastewater and domestic sewage that contain hard-to-biodegradable pollutants, pathogens, toxins, particles, nitrogen and phosphorus pollutants, can be treated by the SFCs anaerobic cleaning. An un-powered SFCs anaerobic sewage bioreactor (see FIG. 5) provided the indigenous anaerobic microbial communities on SFCs an oxygen-free and suitable eco-living environment, and further enhanced the capability of the microbes to digest the pollutants accumulated on SFCs. Small amount of fungi, protozoa and micro-metazoan that grew naturally in the top of SFCs environment, also participated in the decomposition of pollutants. By adjusting the flow velocity and the operating temperature of the bioreactor, the fermentation time and anaerobic processing time could be controlled to optimize the decomposition efficiency of pathogenic bacteria, toxins and other pollutants. The bioreactor was also able to remove the particles. The bioreactor had the characteristics of high bio-phase density, high mass transfer rate, and high load operation. During the pollution decomposition process, SFCs as the pollutant carrier and microbe carrier, were relatively stable themselves and maintained carbon negative. During the anaerobic microbial decomposition process, the pollutants were decomposed into CH₄, nitrogen or other gases. If CH₄ is collected as the clean energy, it helps GHGs emission reduction.

(1) Muddy stench of sewage was made from industrial wastewater, paint wastewater, garbage leachate, kitchen oils, detergents, blue-green algae, particulate matter and urine stench of sewage. The pH of sewage was adjusted to 7.3-8.0 with lime. The sewage was applied to the SFCs anaerobic sewage bioreactor for one year. The outlet water was translucent, with weak smell, no fishy smell. The strains of anaerobic microorganisms came from the indigenous communities in the sewage and from the healthy earthworm homogenate. CH₄ was collected as the clean energy. The bioreactor remained high cleaning efficiency, even at 1-2° C. in winter.

(2) When the above mixture of sewage contained high concentrations of protein or feces and urine components, a higher concentration of ammonia and hydrogen sulfide would be produced, and the activity of anaerobic microorganisms would be inhibited by the gases. To overcome the inhibitory effect of ammonia and hydrogen sulfide gas, the chemical sorption cleaners (as in Example 20) were installed in the gas storage spaces of the SFCs anaerobic sewage bioreactor. The acidic sorbent sorbed ammonia, while the alkaline sorbent sorbed hydrogen sulfide.

(3) Raised for a month in the outlet water from (2), kept the air oxygenating, the fish were in good condition, healthy and lively. The green leafy vegetables were watered with the outlet water from (2). Vegetables grew well in the whole process from germination, emergence, growth to harvest, no pests were observed. Birds appeared to love to feed on them.

(4) The wood SFCs from one-year running of the SFCs anaerobic sewage bioreactor, showed no signs of evident degradation.

(5) The sludge collected from the SFCs anaerobic sewage bioreactor was treated with earthworms, and bio-organic fertilizer was produced.

### Example 23

### Plant SFCs for the Stench Containing Biodegradable Pollutants

For cleaning of various biodegradable pollutants in industrial emission, agricultural emission, domestic emission and sewage emission, SFCs aerobic cleaning method can be used. In a SFCs aerobic gas bioreactor (see air cleaning compartment 3 of FIG. 4), the exhaust and supplementary oxygen were introduced, while the moisture was maintained. The oxygen concentration in the gas-liquid-solid three-phase of the bioreactor was greatly enhanced by the SFCs medium. The oxygen concentration may be ten times higher than the dissolved oxygen saturation concentration in clear water at the standard state (0.1 Mpa, 20° C.). Thus, the bioreactor provided the aerobic microbial communities on SFCs with adequate oxygen supply and suitable eco-living environment, and further enhanced the capability of the microbes to digest the pollutants accumulated on SFCs. Small amount of fungi, protozoa and micro-metazoan that grew naturally in the SFCs environment, also participated in the decomposition of pollutants. The bioreactor had the characteristics of high bio-phase density, high mass transfer rate, and high load operation. During the pollution decomposition process, SFCs as the oxygen carrier, pollutant carrier and microbe carrier, were quite stable themselves and maintained carbon negative.

(1) A stinky and high concentrated stench from the sewage of chemical industry, paint, laundry, rotten vegetables, fish blood and fecal matter, was applied to the SFCs aerobic gas bioreactor. The outlet gas was almost odorless.

(2) A stinky and high concentrated stench from formaldehyde and stinky fish, was applied to the SFCs aerobic gas bioreactor. The outlet gas was almost odorless.

(3) Placed the SFCs aerobic gas bioreactor at a site of high concentration of vehicle exhaust near a traffic tunnel exit. The cleaning effect was evident. The indigenous microbe was from the sludge at the tunnel exit.

(4) The wood SFCs from 18-months running of the SFCs aerobic gas bioreactor, showed no signs of evident degradation.

### Example 24

### Plant SFCs for the Stench Containing Pollutants, Pathogens, Toxins and Eutrophic Substances that are hard to be Biodegradable

A stinky and concentrated mixed malodorous gas from the sewage of chemical industry, paint, garbage leachate, kitchen oils and fecal matter, was first applied to the SFCs gas-liquid exchanger (see FIG. 4 or FIG. 8) to transfer the gaseous pollutants into the liquid phase. The outlet liquid pollutants were then applied to the SFCs anaerobic sewage bioreactor (see FIG. 5). By adjusting the flow velocity and the operating temperature of the bioreactor, the fermentation time and anaerobic processing time can be controlled to optimize the decomposition of the pollutants. The outlet water was translucent, with no fishy smell. CH₄ was collected as the clean energy.

For the treatment of dioxins and other emission from the waste incineration process, SFCs hydrophobic sorption method can be used. The hydrophobic and lipophilic SFCs have a high degree of affinity and sorption to the dioxins due to similar hydrophobicity. So SFCs can play a special role in reducing dioxin emission. The dioxins-sorbed SFCs, may be buried underground, store both carbon and dioxins; or dioxins may be digested by the special microbes, such as the dioxins-degrading Pseudomonas Mendocina.

### Example 25

### Plant SFCs for the Suspended Particles in Air

The air bioreactor for suspended particles was set up as shown in FIG. 8. The indigenous aerobic microbial communities were introduced into the SFC medium. Some fungi, protozoa and micro-metazoan grew naturally in the SFCs environment. The cleaning effects were all evident for the kitchen smoke, tobacco smoke, bio-fuel combustion, motor vehicle exhaust, photochemical smog, fog haze, fly ash, coal dust, sand dust, dust pollution and fine dust. The cleaning efficiency was 80-99%. The cleaning efficiency was related to the particle size, wind velocity, SFCs thickness, SFCs size, moisture of SFCs, aerobic microbial communities, the composition and amount of spray water, and other factors. For those gases containing heavy metals or acidic pollutants, a layer of CMC-treated SFC-V would be added to the lower part of the bioreactor to improve the pre-treatment. Eutrophic domestic sewage could act as the spraying water. For fine particulate matter and aerosol pollution, such as photochemical smog and vehicle exhaust, the capture and cleaning effect could be improved by reducing the size of SFCs, raising the supplying speed of spraying water, or enhancing the chemical cleaning capability of spraying water.

### Example 26

### Plant SFCs for Clean Energy and Bioorganic Fertilizer

(1) Put the plant SFCs that had sorbed pollutants from the sewage of chemical industry, paint, garbage leachate, kitchen waste and fecal matter into a biogas digester. A large quantity of biogas was produced from the biogas digester 10 days later, collected and cleaned as the clean energy. Mixed the fermented residue with SFCs which sorbed kitchen waste and manure. The mixture was the food for earthworms, and was then changed to the bioorganic fertilizer by earthworm digestion.

(2) The plant SFCs were mixed with the fermented domestic solid waste, feces, residue, sewage sludge or bio-degradable industrial solid waste in a volume ratio of 3:1 to 1:3 to form loose bodies. Put the mixture into the biogas digester. A large quantity of biogas was produced 10 days later, collected and cleaned as the clean energy.

(3) The biogas produced above contained not only the main component of CH₄, but also a high concentration of ammonia, hydrogen sulfide and other harmful gases. The impurities had to be cleaned before the biogas becomes the ecological clean energy. The SFCs chemical sorption cleaner as in Example 20 could be used to remove the impurities, that is, the acidic sorbent sorbed ammonia, while the alkaline sorbent sorbed hydrogen sulfide.

(4) Landfill gas could be collected and cleaned by the SFCs chemical sorption cleaner to remove harmful gases such as ammonia and hydrogen sulfide.

### Example 27

### Plant SFCs for Ecological Cleaning of Air and Water

An air bioreactor was set up as in FIG. 6, the scale was adjustable. Various plants, such as aloe, ivy, chlorophytum, chrysanthemum, cactus, asparagus fern and vegetables, were transplanted on the SFCs medium of 60 cm×60 cm×20 cm, together with the introduction of indigenous aerobic microbial communities and 100 earthworms, air blower of 40 w. The coarse filter was made of CMC-treated wood SFC-IV. The outlet upward air was perceptible, its temperature was 1-3° C. lower than that of the surrounding environment, and the relative humidity was 10-20% higher than that of the surrounding environment. The transplants recovered rapidly and grew well, earthworms were active. Small amount of fungi, protozoa and micro-metazoans grew naturally in the SFCs environment. The outlet air was fresh. The cleaning effect for VOCs, formaldehyde, CO₂, CO, SO₂, cigarette smoke, cooking fumes, vehicle exhaust, ozone, dust mites and pollen was evident. Supplied the bioreactor with the burning smoke from biomass 1-2 hours daily for 3 weeks, the cleaning effect was maintained long, and the plants showed no evident side effects. Vegetable seeds were spread on the SFCs of the bioreactor at 2-9° C. in winter, budding appeared after one week, growth was flourished, which proves that the artificial environment is suitable for plant development and growth. In the cold season, the bioreactor was covered by a pyramid-type greenhouse. With the help of heat preservation and pyramid energy from pyramid, the plants grew well, earthworms were active, and the ability to break pollutants was maintained.

The air bioreactor was able to fix atmospheric CO₂. The gaseous CO₂ was first transferred in the liquid phase, sorbed and enriched in SFCs. Then the enriched liquid carbon material was sorbed and fixed by the plant roots.

The air bioreactor was able to clean the aerosol particles and fog haze which occur frequently due to climate warming and man-made pollution.

The air bioreactor was able to clean the dust, vehicle exhaust and fog haze at sites of heavy traffic.

An air bioreactor was also set up as in FIG. 7, the scale was adjustable. Air blower was 40 w, and the SFCs bed was 40 cm×40 cm×40 cm. The sewage treatment layer was about 15 cm high, and the gas treatment layer was about 25 cm high. Various plants, such as aloe, ivy, chlorophytum and asparagus fern were transplanted on the gas treatment layer, together with the introduction of indigenous aerobic microbial communities and 100 earthworms. A mixed sewage from the rotten vegetables, feces and urine was introduced into the sewage treatment layer. The cleaning effect of the outlet water was evident. The outlet upward air was perceptible, its temperature was 1-3° C. lower than that of the surrounding environment, and the relative humidity was 10-15% higher than that of the surrounding environment. The transplants recovered rapidly and grew well, earthworms were active. Small amount of fungi, protozoa and micro-metazoans grew naturally in the SFCs environment. The cleaning effect for VOCs, formaldehyde, CO₂, CO, cooking fumes, ozone, dust mites and pollen was evident.

### Example 28

### Medical and Health Applications of Plant SFC-V

(1) The mixed wood SFC-V and straw SFC-V was taken orally by the inventor, each time 1 gram, three times a day for a month. Weight loss was obtained.

(2) 5 grams of the mixed wood SFC-V and straw SFC-V were taken orally by the inventor, after the inventor drank alcohol. The feeling of tipsy and discomfort was greatly reduced.

### Example 29

### Medical and Health Applications of SFC-I.

(1) Took starch 500 g, glutinous rice flour 500 g, rice flour 500 g, corn flour 500 g, wheat flour 500 g, tiled separately on the tray, then covered with 2-5 cm thickness of sands, placed in a convection oven at temperature of 180° C. to 300° C. When the sands reached the specified temperature, continued to heat for 1-5 hours. Stopped heating, naturally cooled to 100° C., various sourced SFC-Is were produced, all were black carbon blocks. There was some carbon gasification released during the process. The carbon retention rate of SFC-I from raw materials to products was 85-95%.

(2) The starch SFC-I, glutinous rice flour SFC-I, rice SFC-I, corn SFC-I, or wheat flour SFC-I, was spread on water, respectively. All shown good hydrophobicity, kept floating and little water sorbed on the water surface up to a week or more. When the SFC-Is were put into alcohol, there were rapid sorption of alcohol.

(3) The mixed SFC-Is was taken orally by the inventor, each time 1 gram, three times a day for a month. The inventor felt energetic and no discomfort. Weight loss was obtained. 5 grams of the mixed SFC-Is were taken orally by the inventor, after the inventor drank alcohol. The feeling of drunkenness and discomfort was greatly reduced.

### Example 30

### Killing Pathogenic Microorganisms in Water with the Help of Plant SFCs

The SFCs-mediated anaerobic/oxidation sewage treatment system was set up. The system consisted of SFCs anaerobic treatment and SFCs oxidation treatment. The SFCs anaerobic treatment was performed as in FIG. 5. Particularly, aerobic microorganisms were introduced into the compartment 1, so that oxygen in sewage in compartment 1 was largely consumed. In the anoxic environment of compartment 2 and the follow-up compartments, the aerobic pathogenic microorganisms were suppressed or killed, such as Legionella. The effluent from SFCs anaerobic treatment was then introduced into the SFCs oxidation treatment. The SFCs oxidation treatment was performed as in sewage cleaning compartment 1 of FIG. 4. Particularly, the introduced air by air blower contained advanced oxidation medium, such as ozone/UV, so that the aerobic and anaerobic pathogenic microorganisms in sewage were killed in the strongly oxidizing environment, such as Salmonella.

### Example 31

### Plant SFC-Mediated On-Site Cleaning of Organic Wastewater from Laboratory

The SFCs-mediated sorption/oxidation sewage treatment system was set up. The system consisted of SFCs sorption and SFCs advanced oxidation. The SFCs sorption was performed as in filtration/sorption compartment 1 of FIG. 10. Particularly, the sorption was run in semi-closed states to avoid the volatile organic pollutants escaping. There were switch controls at both water inlet and outlet. Poured the organic wastewater into the compartment; switched off the inlet valve; and the organic pollutants were sorbed on SFCs. When the SFCs were saturated with the organic pollutants, removed the saturated SFCs container and replaced by a new one. The saturated SFCs container was sealed for further treatment. Let the mid-effluent enter the SFCs advanced oxidation stage through the outlet switch. The SFCs advanced oxidation was performed as in sorption/biodegradation compartment 3 of FIG. 10. The residual organic pollutants in the mid-effluent were sorbed, oxidized and degraded. Particularly, the oxidation and degradation was not based on the microorganisms, but on the advanced oxidation medium introduced by air blower. One of the common advanced oxidation media is ozone/UV, ozone concentration was 20-1000 mg/m³. The end-effluent could meet emission standards.

For example, the system was applied for treatment of phenol wastewater. Before entering the SFCs advanced oxidation stage, the mid-effluent was adjusted to pH 11. The .OH free radicals from ozone, oxidized the enriched phenol on SFCs to quinones, and then oxidized to fatty acids, eventually became CO₂ and water. Under alkaline conditions, the generation of .OH free radicals from ozone was accelerated, which was good for the oxidative decomposition reaction. After adjusting pH to neutral, the end-effluent was discharged.

### Example 32

### Combination of Plant SFC-V and Zero-Valent Iron

Mixed 1 L of 1 mm granulated wood SFC-V, 1-5 L of 100-mesh zero-valent iron powder, and glue at pH 4-5, press molded and air dried in the shade. The combination had evident capacities for electrostatic protection, electromagnetic shielding, radiation protection, chemical sorption and catalytic decomposition. For example, the combination was able to sorb and reduce electromagnetic waves from television sets and computers; able to clean formaldehyde, ammonia and cigarette smell.

### Example 33

### Combination of Plant SFCs and Chitosan

Preparation of chitosan: Chitin powder was soaked in 40-50% sodium hydroxide solution, stirred for 2 h. The mixture was placed in a household microwave oven (2450 MHz, output power 650 W), heated for 15 min. The solution was poured off; the powder was washed with distilled water to pH neutral. By repeating the above process, and microwave drying, chitosan powder was obtained. Mixing chitosan powder with SFCs powder, their physical compatibility was good.

(1) The mixture of rice SFC-I and chitosan of 5:1 volume ratio was taken orally by the inventor, each time 1 gram, three times a day for a month. Weight loss was obtained.

(2) The mixture of straw SFC-IV and chitosan of 5:1 volume ratio was taken as fodder additive for chickens. Chickens liked the feed, appeared healthy and lively, with no abnormalities.

(3) The mixture of wood SFC-IV and chitosan of 5:1 volume ratio showed high sorption to the oil pollution.

(4) The mixture of wood SFC-IV and chitosan of 5:1 volume ratio showed high cleaning capacity for the wastewater containing lead ions and mercury ions.

(5) The mixture of wood SFC-IV and chitosan of 5:1 volume ratio, was further incubated with the aerobic microorganisms from a matured SFCs aerobic sewage bioreactor. The aerobic microorganisms grew well, and showed visible cleaning effect on gas pollution and water pollution.

(6) The mixture of wood SFC-IV and chitosan of 5:1 volume ratio was put into a SFCs air cleaner (see FIG. 8). Sprayed with 2-5 g/L citric acid, the cleaner showed evident suppression and cleaning effect on Legionella and other pathogenic microorganisms in air.

(7) The mixture of wood SFC-IV and chitosan of 5:1 volume ratio was further mixed and molded with CMC. It showed evident radiation protection.

(8) The mixture of wood SFC-IV and chitosan of 3:1 volume ratio showed evident cleaning effect on the polluted fluid containing negatively charged colloidal particles.

### Example 34

### Alkaline Cellulose Treatment or Calcium Phosphate/Calcium Carbonate Treatment of Plant SFCs

(1) Mixed 2 L SFC-IV with CMC paste, tiled on a baking tray, 2 cm thick, covered with 1 cm thickness of silica sands, heated in a convection oven at 300° C. for 2 hours, the loose and black product was the CMC-treated SFC-V. The product was highly hydrophilic, moisture sorbed, alkaline, and fire-retardant. When the moist product was filled in a chemical sorption air cleaner, the removal efficiencies for CO₂, SO₂ and garbage odor were over 90%.

(2) Mixed SFC-IV with diluted CMC paste, so that the surface of SFC-IV was covered with CMC, and added some lime water. Added 1 M phosphoric acid slowly with stirring until pH reached 8.5, stirred for one more hour. Poured off the supernatant, and put the solid in a convection oven of 100° C., dried and obtained calcium phosphate/calcium carbonate-based SFC-V.

### Example 35

### Silication of Plant SFCs

Mixed 100 g of SiO₂ with 100 g of Na₂SiO₃, added water to make it half-dissolved, pH≧12, and mixed with SFCs, let it stand at room temperature overnight. Squeezed the solution out of the mixture, dried the mixture in an oven. Tiled the mixture on a baking tray and covered with sands, heated at 300° C. in a convection oven for 4 hours, so got the silicified SFCs. The silicified SFCs were non-hardening and fire-retardant.

### Example 36

### Integrated Cleanup of Kitchen Sewage and Kitchen Fume by Plant SFCs

The steps to clean both kitchen sewage and kitchen fume were as follows.

Kitchen sewage pre-cleaning: the kitchen sewage containing catering discharges, oils and detergents was treated as in FIG. 9 to remove residues and partial oils, and then treated by filtration/sorption compartment 1 of FIG. 10 to further remove the oils. The collected residues and oils were for the preparation of bio-fodder and bio-diesel.

Kitchen fume cleaning: Kitchen fume was treated as in FIG. 8 to lower the temperature, to remove the particles, aerosols and chemical odor before discharging. Particularly, the pre-treated sewage was used as the eluant, so that the particles, aerosols and chemical contaminants were dissolved in the eluant collection.

Kitchen sewage cleaning: The eluant collection was treated by filtration/sorption compartment 1 of FIG. 10 to remove the oils, by sorption/biodegradation compartment 3 of FIG. 10 to remove the biodegradable contaminants, and by anaerobic cleaning of FIG. 5 to further remove the biodegradable contaminants. The cleaned water was discharged or recycled for kitchen fume cleaning.

### Example 37

### Earthworms Cleaning of Solid Waste on Plant SFCs

Mixed SFCs and the fermented items such as crushed garbage, feces, sludge from biogas production, sludge from sewage treatment or biodegradable waste, in 3:1 to 1:3 volume ratio, and formed a loose body. Put the loose body in a SFCs bioreactor shown as FIG. 6, loading thickness of 30 cm, the air outlet area of 60 cm×60 cm, air blower of 48 w, inlet air temperature 25-30° C. Particularly, the aerobic microorganisms and earthworms were introduced, but not plants, light and UV light. Fungi, protozoa and micro-metazoan grew naturally in the environment. The top of the bioreactor was partly sheltered and sprayed timely to create a dark, damp, warm environment that earthworms like. The low-noise air blower was applied to create a quiet, breathable, odorless environment that earthworms like. The mixture of SFCs and solid waste can be placed on the up-down multi-layer stacked plates. There were perforated partitions at the bottom of stacked plates. Earthworms can move freely between the layers since same generation of earthworms like to live together. Fresh air was provided; the suitable cross-section wind was as mild as breeze, the velocity may be less than 3 m/min. Those solid wastes containing high salt or high pesticide residues, which are harmful to earthworms, should not be treated in this process.

Eco-organic fertilizer can be generated from the mixture of SFCs and the fermented crushed domestic garbage, after the synergetic decomposition by earthworms, microbes, fungi, protozoa and micro-metazoan. Additional mixture can be added from top of the bioreactor, while the generated fertilizer can be removed from bottom. The earthworm bodies that have treated high concentration of heavy metals in solid waste, due to their enrichment with heavy metals, should be used with caution in other recycling applications.

### Example 38

### Yeast Cleaning of Carbohydrates Waste on Plant SFCs

Mixed SFCs, humus and the fermented carbohydrates waste or crushed garbage in 3:1:3 volume ratio to form a loose body. Put the loose body in a SFCs bioreactor shown as FIG. 6, loading thickness of 40 cm, the air outlet area of 60 cm×60 cm, air blower of 48 w, inlet air temperature of 20-30° C. Suitable cross-section wind was as mild as breeze, the velocity may be less than 3 m/min. Particularly, the yeast was introduced, but not plants, light and UV light. Other aerobic microorganisms, earthworms, fungi, protozoa and micro-metazoan grew naturally in the environment. The top of the bioreactor was sheltered and sprayed timely.

Yeast used the carbohydrate wastes such as starch, sugars, organic acids as the carbon source for aerobic metabolism. Twenty days later, the carbohydrate waste on SFCs was decomposed and matured softly; odorless; volume reduced more than 40%. The matured mixture became ecological organic fertilizer.

### Example 39

### Molecular Sieve Formation between Plant SFCs, Boric Acid and Reducing Sugar

A dense polymer gel could be formed by the reversible bonding of boric acid and the adjacent cis-2-hydroxy groups of reducing sugar. When the gel was polymerized on the porous surfaces of SFCs, a molecular sieve coated SFCs porous material was formed. The complex could be used for storage of chemicals or removal of heavy metal ions and other chemical pollutants from fluid. By changing the concentrations of boric acid and reducing sugar, pore sizes and pore proportions of the complex could be adjusted, in order to efficiently store or remove pollutants with different molecular sizes. If the SFCs are pretreated chemically prior to the gel coating, the capacity of storage or removal can be enhanced.

For example, mixed 500 g powdered wood SFC-V and 1000 ml of 200 mM sodium borate, pH 10, then added 1000 ml of 100 mM fructose (or 1000 ml of 100 mM mannose or glucose), mixed evenly, let it stand aside for 2 hours. The molecular sieve coated SFCs porous material was obtained. Filled the material in a gas mask, it could effectively eliminate VOCs, formaldehyde, CO₂, CO, SO₂, cigarette smoke, cooking fume smell and so on.

### Example 40

### Air Cleaning without Consuming Electricity

A chimney was built near an 11-meters high building, chimney inner diameter 30 cm, 10.5 meters high. A clear-plastic shed of 2 m×3 m wide was connected to the bottom of chimney, and a 1 cm gap was between the ground and the bottom of shed. A SFCs bioreactor (FIG. 6) was connected to the top of chimney, with no air blower built in. The mixture in the bioreactor was the same as that in Example 37. Due to the greenhouse effect of the clear-plastic shed, the entering polluted air was solar heated up or concave mirror heated up. Differences in temperature and pressure between top and bottom of chimney, drove the air up and passed through the bioreactor; the air got cleaned and discharged. If the clear plastic shed was designed as a pyramid shape, the dynamic power obtained could be further improved.

### Example 41

### Integrated Cleanup of Carbon and Nitrogen Pollution in Water and Gas by Plant SFCs

Integrated cleanup of eutrophic domestic sewage, ammonia nitrogen from sewage treatment or vehicle exhaust was performed following the mixing of biological denitrification and chemical denitrification. The bio-denitrification reactor (as in FIG. 5), chemical catalytic denitrification reactor (as in FIG. 5) and chemical catalytic nitration reactor (as in sewage cleaning compartment 1 of FIG. 4) or bio-nitrification reactor (as in sewage cleaning compartment 1 of FIG. 4) were serially connected. Domestic sewage was introduced into the bio-denitrification reactor, which was filled with SFCs and the attached denitrifying bacteria. The 1^{st} effluent was adjusted to pH 2-3 with acid, then flowed to the chemical catalytic denitrification reactor, which was filled with SFCs and the attached zero-valent iron powder. The 2nd effluent was adjusted to pH neutral or slight alkaline with alkali, together with ammonia nitrogen from sewage treatment or vehicle exhaust, then flowed to the chemical catalytic nitrification reactor, which was filled with SFCs and the attached manganese dioxide; or flowed to bio-nitrification reactor, which was filled with SFCs and the attached nitrifying bacteria. The 3^{rd} effluent was returned to the bio-denitrification reactor. The final effluent had less than 2 mg/l of ammonia nitrogen, less than 10 mg/l of nitrate nitrogen, less than 50 mg/l of COD, and outlet nitrogen cleaning rate of 75-90%. Advanced carbon mitigation and advanced non-carbon mitigation were achieved.

### Example 42

### Storage of SFC-VIII in Pyramid Warehouse; Plants in Pyramid Greenhouse. Pyramid was Placed by North-South Direction

(1) In the spring and summer, fresh urine, milk, yogurt, flowers, vegetable leaves, dead insects, fish offal, pork and other samples were put into the opened Petri dishes and placed inside a pyramid warehouse. The same samples as controls were placed inside a wooden box at a distance of 5 meters from the pyramid. A month later, inside the pyramid, urine turned slightly smelly but still clear; milk turned into cheese; yogurt preserved the original flavor; flowers and vegetable leaves were in serious dehydration; dead insects, fish offal and pork smelled slightly and dehydrated. On the contrary, in the wooden box, urine turned foul-smelling; milk turned stench of corruption; a heavy layer of green mold shown on yogurt; flowers and leaves rot; dead insects, fish offal and pork turned stench of corruption.

(2) Dried soybeans and peanuts under sun, water content about 20%, were put into the pyramid warehouse for one year's storage. Took the samples out. The germination rate and the crop of the pyramid soybeans were superior to that of the control. The color, smell and taste of the pyramid peanuts were superior to that of the control. The prevalence rate of aflatoxin of the pyramid peanuts was evidently lower than that of the control.

(3) Soybeans and peanuts were stored in a mini-pyramid warehouse in a building. It showed mildew resistant. The pyramid was able to sorb indoor electromagnetic pollution.

(4) A variety of animal and plant SFC-VIII were prepared as (12)-(14) in Example 1. Put the samples in a dry pyramid warehouse. After a total of eight months of spring, summer and autumn, all of the samples were further dehydrated, hardened, odorless, no pests and flies.

(5) Took one heavy metal poisoned dead bird and one pesticide poisoned dead bird, removed their internal organs, embedded and dried in sodium carbonate or lime powder for 10 days, and finally placed in a dry pyramid warehouse. Six months later, both samples were further dehydrated, hardened, odorless, no pests and flies.

(6) Set up a pyramid-shaped greenhouse: bracket made of wood or bamboo, four-corner coned, base length of 100 cm, side edge length 95 cm, plastic film coated, air holes on the top, 2 cm gap between the ground and the base. Vegetables were grown inside with no use of pesticides. Vegetables grew better than the control group, no pests were observed. The taste of vegetables was good.

(7) Two bottles of wine were stored in a mini-pyramid warehouse in a room. Six months later, the taste was mellower and more refreshing than that of the control group.

What is claimed is:

1. A system of reducing the total amount of carbons in atmosphere to fight climate change, comprising: a carbon-sourcing subsystem of fixing the gaseous carbon dioxide and non-carbon substances by a natural process of photosynthesis into solid and perishable plant biomass, and preventing said plant biomass by a natural process of decomposition into greenhouse gases; a carbon-stabilizing subsystem of cost-effectively converting said plant biomass into the eco-friendly carbon-rich and carbon-stabilized products of Stabilized Functional Carbons (SFCs), getting no less than 75% of the carbon conversion rates from said plant biomass to said SFCs; a carbon-storage subsystem of storing said SFCs as the stable carbon sink under easy-applied and easy-maintained conditions for at least 40 years to reduce total carbons in the circulation; and a carbon-utilizing subsystem of reducing the carbon and non-carbon pollution emission from various sources by the resource utilization of said SFCs in a non-destructive manner; comprising the steps of:
(a) sourcing said plant biomass;
(b) mixing said plant biomass with 0-95% (v/v) stabilizing agent;
(c) covering said mixture with silica sands or iron sands, and heating at a temperature of 180°-350° C. for a time period of 30 minutes-24 hours, while, at the same time, flowing heat air over top of said sands, such that moisture and volatile substances from said mixture being removed by said air, said volatile substances being further condensed and collected as new energy source or new resource, remaining gas being discharged after being cleaned by air cleaner;
(d) cooling the treated substances to ambient temperature, removing said sands, and getting SFC-I, which possesses stabilized carbon structure of at least 40 years' life span and multi-functional properties;
(e) storing said SFC-I, achieving primary carbon and non-carbon mitigation; or resource-utilizing said SFC-I on various pollution emission sources, achieving advanced carbon and non-carbon mitigation.

2. A system of reducing the total amount of carbons in atmosphere to fight climate change, comprising: a carbon-sourcing subsystem of fixing the gaseous carbon dioxide and non-carbon substances by a natural process of photosynthesis into solid and perishable plant biomass, and preventing said plant biomass by a natural process of decomposition into greenhouse gases; a carbon-stabilizing subsystem of cost-effectively converting said plant biomass into the eco-friendly carbon-rich and carbon-stabilized products of Stabilized Functional Carbons (SFCs), getting no less than 75% of the carbon conversion rates from said plant biomass to said SFCs; a carbon-storage subsystem of storing said SFCs as the stable carbon sink under easy-applied and easy-maintained conditions for at least 40 years to reduce total carbons in the circulation; and a carbon-utilizing subsystem of reducing the carbon and non-carbon pollution emission from various sources by the resource utilization of said SFCs in a non-destructive manner; comprising the steps of:
(a) sourcing said plant biomass;
(b) mixing said plant biomass with 0-95% (v/v) stabilizing agent;
(c) covering said mixture with silica sands or iron sands, and sun heating by one or a group of concave mirror for a time period of 2 minutes-5 hours, while, at the same time, flowing heat air over top of said sands, such that moisture and volatile substances from said mixture being removed by said air, said volatile substances being further condensed and collected as new energy source or new resource, remaining gas being discharged after being cleaned by air cleaner;
(d) cooling the treated substances to ambient temperature, removing said sands, and getting SFC-II, which possesses stabilized carbon structure of at least 40 years' life span and multi-functional properties;
(e) storing said SFC-II, achieving primary carbon and non-carbon mitigation; or resource-utilizing said SFC-II on various pollution emission sources, achieving advanced carbon and non-carbon mitigation.

3. A system of reducing the total amount of carbons in atmosphere to fight climate change, comprising: a carbon-sourcing subsystem of fixing the gaseous carbon dioxide and non-carbon substances by a natural process of photosynthesis into solid and perishable plant biomass, and preventing said plant biomass by a natural process of decomposition into greenhouse gases; a carbon-stabilizing subsystem of cost-effectively converting said plant biomass into the eco-friendly carbon-rich and carbon-stabilized products of Stabilized Functional Carbons (SFCs), getting no less than 75% of the carbon conversion rates from said plant biomass to said SFCs; a carbon-storage subsystem of storing said SFCs as the stable carbon sink under easy-applied and easy-maintained conditions for at least 40 years to reduce total carbons in the circulation; and a carbon-utilizing subsystem of reducing the carbon and non-carbon pollution emission from various sources by the resource utilization of said SFCs in a non-destructive manner; comprising the steps of:
(a) sourcing said plant biomass;
(b) mixing said plant biomass with 0-95% (v/v) stabilizing agent and 0-0.5 M microwave-sorbing medium;
(c) covering said mixture with silica sands, and heating by microwave for a time period of 5 minutes-5 hours, while, at the same time, flowing heat air over top of said sands, such that moisture and volatile substances from said mixture being removed by said air, said volatile substances being further condensed and collected as new energy source or new resource, remaining gas being discharged after being cleaned by air cleaner;
(d) cooling the treated substances to ambient temperature, removing said sands, and getting SFC-III, which possesses stabilized carbon structure of at least 40 years' life span and multi-functional properties;
(e) storing said SFC-III, achieving primary carbon and non-carbon mitigation; or resource-utilizing said SFC-III on various pollution emission sources, achieving advanced carbon and non-carbon mitigation.

4. A system of reducing the total amount of carbons in atmosphere to fight climate change, comprising: a carbon-sourcing subsystem of fixing the gaseous carbon dioxide and non-carbon substances by a natural process of photosynthesis into solid and perishable plant biomass, and preventing said plant biomass by a natural process of decomposition into greenhouse gases; a carbon-stabilizing subsystem of cost-effectively converting said plant biomass into the eco-friendly carbon-rich and carbon-stabilized products of Stabilized Functional Carbons (SFCs), getting no less than 75% of the carbon conversion rates from said plant biomass to said SFCs; a carbon-storage subsystem of storing said SFCs as the stable carbon sink under easy-applied and easy-maintained conditions for at least 40 years to reduce total carbons in the circulation; and a carbon-utilizing subsystem of reducing the carbon and non-carbon pollution emission from various sources by the resource utilization of said SFCs in a non-destructive manner; comprising the steps of:
(a) sourcing said plant biomass;
(b) heating said plant biomass in an oxidizing medium at a temperature of 110°-350° C. for a time period of 5 minute-24 hours, while, at the same time, flowing said oxidizing medium over said plant biomass, such that dusts, moisture and volatile substances being removed by said medium, and said dusts being further collected as the recycled raw materials, said volatile substances being further condensed and collected as new energy source or new resource, remaining gas being discharged after being cleaned by air cleaner;
(c) cooling the treated substances to ambient temperature, and getting SFC-IV, which possesses stabilized carbon structure of at least 40 years' life span and multi-functional properties;
(d) storing said SFC-IV, achieving primary carbon and non-carbon mitigation; or resource-utilizing said SFC-IV on various pollution emission sources, achieving advanced carbon and non-carbon mitigation.

5. A system of reducing the total amount of carbons in atmosphere to fight climate change, comprising: a carbon-sourcing subsystem of fixing the gaseous carbon dioxide and non-carbon substances by a natural process of photosynthesis into solid and perishable plant biomass, and preventing said plant biomass by a natural process of decomposition into greenhouse gases; a carbon-stabilizing subsystem of cost-effectively converting said plant biomass into the eco-friendly carbon-rich and carbon-stabilized products of Stabilized Functional Carbons (SFCs), getting no less than 75% of the carbon conversion rates from said plant biomass to said SFCs; a carbon-storage subsystem of storing said SFCs as the stable carbon sink under easy-applied and easy-maintained conditions for at least 40 years to reduce total carbons in the circulation; and a carbon-utilizing subsystem of reducing the carbon and non-carbon pollution emission from various sources by the resource utilization of said SFCs in a non-destructive manner; comprising the steps of
(a) sourcing said plant biomass;
(b) heating said plant biomass in an oxidizing medium at a temperature of 110°-350° C. for a time period of 5 minute-24 hours, while, at the same time, flowing said oxidizing medium over said plant biomass, such that dusts, moisture and volatile substances being removed by said medium, and said dusts being further collected as the recycled raw materials, said volatile substances being further condensed and collected as new energy source or new resource, remaining gas being discharged after being cleaned by air cleaner;
(c) cooling the treated substances to ambient temperature, and getting SFC-IV;
(d) mixing said SFC-IV with 0-95% (v/v) stabilizing agent and 0-0.5 M microwave-sorbing medium;
(e) treating said mixture as step (c) of claim 1, cooling and removing said sands, and getting SFC-V; or treating said mixture as step (c) of claim 2, cooling and removing said sands, and getting SFC-VI; or treating said mixture as step (c) of claim 3, cooling and removing said silica sands, and getting SFC-VII;
(f) storing said SFC-V, SFC-VI, or SFC-VII, achieving primary carbon and non-carbon mitigation; or resource-utilizing said SFC-V, SFC-VI, or SFC-VII on various pollution emission sources, achieving advanced carbon and non-carbon mitigation.

6. A system of reducing the total amount of carbons in atmosphere to fight climate change, comprising: a carbon-sourcing subsystem of fixing the gaseous carbon dioxide and non-carbon substances by a natural process of photosynthesis into solid and perishable plant biomass or subsequently into solid and perishable animal biomass, and preventing said biomass by a natural process of decomposition into greenhouse gases; a carbon-stabilizing subsystem of cost-effectively converting said biomass into the eco-friendly carbon-rich and carbon-stabilized products of Stabilized Functional Carbon-VIII (SFC-VIII), getting no less than 75% of the carbon conversion rates from said plant biomass to said SFC-VIII; a carbon-storage subsystem of storing said SFC-VIII as the stable carbon sink under easy-applied and easy-maintained conditions for at least 40 years to reduce total carbons in the circulation; and a carbon-utilizing subsystem of reducing the carbon and non-carbon pollution emission from various sources by the resource utilization of said SFC-VIII in a non-destructive manner; comprising the steps of:
(a) sourcing said plant biomass or said animal biomass;
(b) pre-dehydrating and drying said biomass to a water content of 10-20%;
(c) putting said pre-dehydrated biomass into a dry pyramid warehouse, or burying said pre-dehydrated biomass in a desert, continuing further dehydration and drying until a water content of less than 8% being reached, and maintaining the state of dehydration and drying;
(d) getting SFC-VIII;
(e) storing said SFC-VIII in said pyramid warehouse or in said desert, achieving primary carbon and non-carbon mitigation; or resource-utilizing said SFC-VIII on various pollution emission sources in said pyramid warehouse or in said desert, achieving advanced carbon and non-carbon mitigation.

7. A method according to claim 1, 2, 3, 4, 5, or 6 wherein said plant biomass is selected from the group comprising wood, barks, leaves, bars, stems, shells, skins, roots, flowers, seeds, grasses, pulp, seaweed, sponge, sugar cane, sweet sorghum, sugar beet, beans, rice, wheat, flour, corn, rye, barley, oats, millet, hemp, linen, ramie, peanut, oil palm, tobacco, tea, cotton, cloth, paper, cardboard, paper pulp, urban organic waste, garden wastes, mushroom culture residues, algae, fungi, said plant biomass that are chemically contaminated, said plant biomass that are fermented, and combinations thereof; wherein said animal biomass is selected from the group comprising protozoan, coelenterate, annelid, mollusks, arthropod, fishes, amphibia, reptiles, birds, mammals, said animal biomass that are chemically contaminated, and combinations thereof; wherein said animal biomass is from the whole bodies, organs, tissues, cells, and combinations thereof.

8. A method according to claim 1, 2, 3, or 5 wherein said stabilizing agent comprises fruits of plants, by-products of petroleum, proteins, fats, gels, surfactants, chelators, sugars, salts, acids, and combinations thereof.

9. A method according to claim 3 or 5 wherein said microwave-sorbing medium comprises ethanol, acids, alkalis, salts, sea water, and combinations thereof.

10. A method according to claim 4 or 5 wherein said oxidizing medium comprises air, oxygen, ozone, hydrogen peroxide, and combinations thereof.

11. A method according to claim 1, 2, 3, 4 or 5 wherein said “storing said SFCs, achieving primary carbon and non-carbon mitigation” further comprises storing said SFCs in compressed package or vacuumed package after high-pressure compressing, the storage space being saved by 30-70%, while the long-term stability being enhanced by 20%.

12. A method according to claim 1, 2, 3, 4 or 5 wherein said “resource-utilizing said SFCs on various pollution emission sources, achieving advanced carbon and non-carbon mitigation” further comprises mixing said SFCs with hydrophobic polymer materials, hydrophilic organic materials, inorganic materials, and combinations thereof to form composites; thus achieving said advanced mitigation by raw material sourcing of said composites, preparation of said composites, improved stability of said composites, utilization of said composites on building energy conservation, resource and energy saving, and pollution control.

13. A method according to claim 12 wherein said hydrophobic polymer materials are selected from the group comprising plastics, rubbers, resins, paraffin, Vaseline, bitumen, tar, and combinations thereof; wherein said hydrophilic organic materials are selected from the group comprising sodium carboxymethyl cellulose (CMC), chitosan, surfactants, chelating agents, and combinations thereof; wherein said inorganic materials are selected from the group comprising zero-valent iron, manganese dioxide, fly ash, coal gangue, slag, loess, rock wool, glass wool, stone powder, sand, cement, lime, gypsum, calcium phosphate, boric acid, and combinations thereof.

14. A method according to claim 1, 2, 3, 4 or 5 wherein said “resource-utilizing said SFCs on various pollution emission sources, achieving advanced carbon and non-carbon mitigation” further comprises burying said SFCs in soil; thus achieving said advanced mitigation by increase of soil carbon storage, control of soil pollution, reduction of application of chemical fertilizers and pesticides, reduction of nitrous oxide and methane emissions, and combinations thereof, thereby resulting in guarantee of food safety, protection of biodiversity, restoration of natural ecosystem, and combinations thereof.

15. A method according to claim 1, 2, 3, 4 or 5 wherein said “resource-utilizing said SFCs on various pollution emission sources, achieving advanced carbon and non-carbon mitigation” further comprises making human or animals intake of said SFCs; thus achieving said advanced mitigations by sorption and discharge of harmful substances, thereby resulting in weight loss, guarantee of food safety, protection of public health, reduction of medical burden, and combinations thereof.

16. A method according to claim 1, 2, 3, 4 or 5 wherein said “resource-utilizing said SFCs on various pollution emission sources, achieving advanced carbon and non-carbon mitigation” further comprises letting polluted fluid pass through said SFCs; the particulates, pathogenic micro-organisms or chemical contaminants in said fluid being sorbed, concentrated, stored or degraded; thus achieving said advanced mitigation by reducing pollution, saving resources and energy sources, developing new energy source and resources, and combinations thereof.

17. A method according to claim 1, 2, 3, 4 or 5 wherein said “resource-utilizing said SFCs on various pollution emission sources, achieving advanced carbon and non-carbon mitigation” further comprises mixing said SFCs with redox catalysts to form a mixture; letting polluted fluid pass through said mixture; the particulates, pathogenic micro-organisms or chemical contaminants in said fluid being sorbed, concentrated, and catalyzed; thus achieving said advanced mitigation by reducing pollution, reducing GHGs emission, developing new energy source and resources, and combinations thereof.

18. A method according to claim 1, 2, 3, 4 or 5 wherein said “resource-utilizing said SFCs on various pollution emission sources, achieving advanced carbon and non-carbon mitigation” further comprises setting up a three-dimensional ecosystem made of said SFCs and bioactive substances; supplying aerobic and ventilated or anaerobic environment to said ecosystem; letting polluted fluid pass through said ecosystem; the particulates, pathogenic micro-organisms or chemical contaminants in said fluid being sorbed, concentrated and cleaned by said SFCs; the said contaminants being further metabolized and degraded by said bioactive substances living on said SFCs; thus achieving said advanced mitigation by reducing pollution, saving resources and energy resources, developing new energy source and resources, and combinations thereof.

19. A method according to claim 18 wherein said bioactive substances comprises the cell lysate of plant leaves or algae that contains carbonic anhydrase isoenzyme; supplying gaseous carbon dioxide as the substrate for said isoenzyme; letting said carbon dioxide pass through said SFCs and said isoenzyme; said carbon dioxide being sorbed and concentrated by said SFCs, then being catalyzed by said isoenzyme into liquid bicarbonate, and being further transformed into solid carbonate precipitation; thus achieving said advanced mitigation by reducing atmospheric carbon dioxide.

20. A method according to claim 18 wherein said bioactive substances comprises the group of plant roots, active exudates of plant roots, stems and leaves of plants, algae, microorganisms, yeast, fungi, enzymes, earthworms, protozoa, micro-metazoan, and combinations thereof; supplying the contaminants in the polluted fluid as the nutrients or substrates, supplying gaseous carbon dioxide as the substrate for photosynthesis, and supplying the aerobic and ventilated environment; letting said fluid pass through said SFCs and said bioactive substances; carbon dioxide, particulates, pathogenic micro-organisms or chemical contaminants in said fluid being sorbed, concentrated, utilized, degraded and cleaned; thus achieving said advanced mitigation by fixing carbon dioxide, nitrifying ammonia and nitrogen oxide, reducing pollution emission, producing biomass, and combinations thereof.

21. A method according to claim 18 wherein said bioactive substances comprises the group of plant roots, active exudates of plant roots, stems and leaves of plants, algae, microorganisms, yeast, fungi, enzymes, earthworms, protozoa, micro-metazoan, and combinations thereof; supplying solid organic waste as the nutrients or substrates, supplying gaseous carbon dioxide as the substrate for photosynthesis, and supplying the aerobic and ventilated environment; mixing said SFCs, said bioactive substances and said waste; said waste being degraded in short time in the aerobic environment; thus achieving said advanced mitigation by fixing carbon dioxide, reducing GHGs emission from anaerobic decomposition, cleaning solid waste, reducing pollution, producing biomass, and combinations thereof.

22. A method according to claim 6 wherein said “resource-utilizing said SFC-VIII on various pollution emission sources, achieving advanced carbon and non-carbon mitigation” further comprises reserving said SFC-VIII as plant-derived food, plant seeds or animal-derived food in pyramid warehouse or in desert, or using said SFC-VIII to build a pyramid warehouse; thus achieving said advanced mitigation by reserving food and seeds, saving energy, reducing consumption, reducing pollution emission, reducing electromagnetic pollution, and combinations thereof.
